(19) United States
(12) Patent Application Publication
(10) Pub. No.: US 2009/0169015 A1
(43) Pub. Date: Jul. 2, 2009

(54) QUANTUM KEY DISTRIBUTION METHOD, COMMUNICATION SYSTEM, AND COMMUNICATION DEVICE

(75) Inventor: Yodai Watanabe, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Inter-Univ Res Ins Corp / Res Org of info and Syst, Minato-ku (JP)

(21) Appl. No.: 11/814,619

(22) PCT Filed: Jan. 24, 2006
(86) PCT No.: PCT/JP2006/301039

§ 371 Date: Dec. 8, 2008

(30) Foreign Application Priority Data
Jan. 24, 2005 (JP) 2005-015466
Jun. 28, 2005 (JP) 2005-188865

(51) Int. Cl. H04L 9/08; H04L 9/00

(52) U.S. Cl. 380/278; 380/256

(57) ABSTRACT

A quantum key distribution method according to the present invention includes an error probability estimation step of estimating error probabilities of transmission data and the received data, an error correcting step of correcting errors in the received data based on error correcting information, a matching determination step of determining whether the transmission data and the received data after correcting errors match, and an information amount estimating step of estimating an amount of information leaked to an adversary through a quantum communication path, and further compresses data based on the amount of information made public in a process of processing via a public communication path and an estimated value of the amount of information leaked to the adversary through the quantum communication path to make the data after compression a cryptographic key shaped by devices.

### TECHNICAL FIELD

The present invention relates to a quantum key distribution method that can generate a shared key whose security is highly ensured, and in particular, relates to a quantum key distribution method that can ensure security even in a more realistic implementation in which, for example, there are errors in quantum states of a source and a detector by applying error correcting technology and privacy amplification technology and a communication device that can realize the quantum key distribution.

### BACKGROUND ART

A conventional quantum cryptographic system will be described below. In recent years, optical communication is widely used as a high-speed large-capacity communication technology. In such an optical communication system, communication is performed by on/off of light and a large amount of photons is transmitted when light is on, failing to realize a communication system in which a quantum effect directly manifests itself.

In contrast, in a quantum cryptographic system, photons are used as communication media and 1-bit information is transmitted by one photon so that quantum effects such as the uncertainty principle can be brought about. If, at this point, an adversary measures the photon by selecting an appropriate basis without knowing its quantum state such as the polarization and phase, the quantum state changes. Therefore, the receiving side can recognize whether transmission data has been intercepted by checking whether the quantum state of the photon has changed.

FIG. 9 is a diagram showing an overview of conventional quantum key distribution using polarization. For example, a measuring apparatus that can identify polarization in horizontal and vertical directions correctly identifies light polarized in the horizontal direction (0°) and that polarized in the vertical direction (90°) on a quantum communication path. In contrast, a measuring apparatus that can identify polarization in slanting directions (45°, 135°) correctly identifies light polarized in the 45° direction and light polarized in the 135° on a quantum communication path.

As described above, each measuring apparatus can recognize light polarized in specified directions correctly, but if, for example, light polarized in slanting directions is measured by a measuring apparatus that can identify polarized light in the horizontal and vertical directions (0°, 90°), light polarized in the horizontal direction and that polarized in the vertical direction will be identified randomly with a 50% probability each. That is, if a measuring apparatus that is not provided for identifiable polarization directions is used, the polarized direction cannot be correctly identified even if measurement results thereof are analyzed.

In the conventional quantum key distribution shown in FIG. 9, a key is shared by a sender and a receiver without being known to an adversary by using the above indeterminateness (randomness) (See, for example, Non-Patent Literature 1). The sender and receiver can use, in addition to a quantum communication path, a public communication path.

Here, a procedure for sharing a key will be described. First, the sender generates a random number sequence (a sequence of 1 and 0: transmission data) and further determines a transmission code (+: corresponding to a measuring apparatus that can identify light polarized in the horizontal and vertical directions, x: corresponding to a measuring apparatus that can identify light polarized in the slanting directions) randomly. The polarization direction of light to be transmitted is automatically determined by a combination of the random number sequence and the transmission code. Here, light polarized in the horizontal direction by combining 0 and +, light polarized in the vertical direction by combining 1 and +, light polarized in the 45° direction by combining 0 and x, and light polarized in the 135° direction by combining 1 and x are each transmitted to a quantum communication path (transmission signal).

Next, the receiver determines a reception code (+: corresponding to a measuring apparatus that can identify light polarized in the horizontal and vertical directions, x: corresponding to a measuring apparatus that can identify light polarized in the slanting directions) randomly to measure light on the quantum communication path (received signal). Then, received data is obtained by the combination of the reception code and the received signal. Here, 0 as the combination of light polarized in the horizontal direction and +, 1 as the combination of light polarized in the vertical direction and +, 0 as the combination of light polarized in the 45° direction and x, and 1 as the combination of light polarized in the 135° direction and x are each received as the received data.

Next, the receiver transmits the reception code to the sender via the public communication path to examine whether measurement of the receiver is a measurement using the same basis as that of the sending side, that is, measurement has been made using a correct measuring apparatus. Upon receipt of the reception code, the sender examines whether the measurement has been made using the correct measuring apparatus and returns its result to the receiver via the public communication path.

Next, the receiver retains only received data corresponding to received signals received by the correct measuring apparatus and discards the rest. At this point, the retained received data is shared by the sender and the receiver.

Next, the sender and the receiver each send a predetermined number of pieces of data selected from the shared data to their respective communication parties via the public communication path. Then, they check whether received data match the data they hold. If, for example, there is any piece of data in the checked data that does not match, it is judged that there is an adversary and the shared data is discarded to start over the procedure for sharing a key from the beginning. If, on the other hand, all checked data matches, it is judged that there is no adversary and data used for checking is discarded to make the retained shared data a shared key between the sender and the receiver.

Nonpatent Literature 1: Bennett, C. H. and Brassard, G.: Quantum Cryptography: Public Key Distribution and Coin Tossing, In Proceedings of IEEE Conference on Computers, System and Signal Processing, Bangalore, India, pp. 175-179 (DEC. 1984)

### DISCLOSURE OF INVENTION

### Problem to be Solved by the Invention

However, since no erroneous communication path is assumed in the conventional quantum key distribution shown in FIG. 9 and thus, if there is an error, adversarial activity is assumed and the shared data (shared key) is discarded, causing a problem that generation efficiency of a shared key could become very low in some transmission path. Also, there is a problem that security is not ensured if there is an error in one of a source and a detector.

The present invention has been made in view of the above circumstances and an object thereof is to obtain a quantum key distribution method that can achieve high key generation efficiency by correcting data errors on a transmission path using an error correcting code having an extremely high level of characteristics and with which security is highly ensured even in a realistic implementation in which a source and a detector have error by estimating an amount of information leaked to an adversary in consideration of information about characteristics of the source and detector.

### Means of Solving the Problems

To solve the above problems and achieve the above objects, a quantum key distribution method according to one aspect of the present invention, executed by a first communication device transmitting a quantum state specified by two random number sequences corresponding to a basis and data to a quantum communication path and a second communication device obtaining data by measuring the quantum state on the quantum communication path using the basis specified by the random number sequences with data obtained by measurement using the same basis as that of a sending side set as received data and a random number sequence corresponding to the received data set as transmission data, includes an error probability estimation step of estimating an error probability of data used for key generation based on , after extracting data of predetermined numbers of pieces of the transmission data and the received data at the same positions, a degree of matching (error probability) of partial data after extraction, and an information amount estimation step of estimating an amount of information leaked to an adversary through the quantum communication path based on an estimated value of the error probability and information about characteristics of a quantum state generator provided to the first communication device, wherein each communication device makes the transmission data and the received data after compression based the estimated value of the amount of information leaked to the adversary a cryptographic key shared by each communication device.

Another aspect of the present invention is the quantum key distribution method, wherein in the information amount estimation step, the amount of information leaked to the adversary through the quantum communication path is estimated based on the estimated value of error probability and information about characteristics of the quantum state generator provided to the first communication device and a quantum state measuring apparatus provided to the second communication device.

Still another aspect of the present invention is the quantum key distribution method, wherein in the information amount estimation step, the transmission data held by the first communication device and the received data held by the second communication device are each divided into a predetermined number of portions and an amount of information leaked to the adversary is estimated for each portion of the divided data.

The quantum key distribution method according to still another aspect of the present invention, further includes a matching determination step of performing determination processing whether the transmission data held by the first communication device and the received data held by the second communication device match based predetermined determination information and, if a result of the determination is a mismatch, discarding data held by each of the communication devices, wherein in the matching determination step, the first communication device determines first determination information of a specific bit length by calculating “a predetermined random matrix×the transmission data held by the first communication device” as the predetermined determination information and transmits the first determination information to the second communication device via the public communication path, the second communication device determines second determination information of the same bit length as that of the first determination information by calculating “the predetermined random matrix×the received data held by the second communication device” as the predetermined determination information and transmits the second determination information to the first communication device via the public communication path, subsequently, the first communication device determines whether the first determination information and the second determination information obtained from the second communication device match as the determination processing, and the second communication device, on the other hand, determines whether the second determination information and the first determination information obtained from the first communication device match as the determination processing.

Still another aspect of the present invention is the quantum key distribution method, wherein if a two-level quantum system is assumed, the information amount estimation step, includes, a first process in which an upper limit of a variation distance between an approximation protocol (a protocol using a good-natured quantum state) that is relatively easy to analyze and an actual protocol (a protocol using a quantum state including transmission errors in an actual situation), a second process in which the upper limit of a probability that the estimated value of error probability is estimated to be smaller than a true value when a basis that is opposite to an actual basis is used in the approximation protocol, a third process in which the upper limit of a conditional probability of the received data and intercepted information when the transmission data is set as a condition is calculated, a fourth process in which the amount of eavesdropping in the approximation protocol is calculated based on the upper limit of the probability that the estimated value of error probability is estimated to be smaller than the true value obtained in the second process and the upper limit of the conditional probability obtained in the third process, and a fifth process in which the amount of eavesdropping in the actual protocol is calculated based on the amount of eavesdropping in the approximation protocol and the upper limit of the variation distance obtained in the first process and its result is set as the amount of information leaked to the adversary through the quantum communication path.

Still another aspect of the present invention is the quantum key distribution method, wherein if a two-level quantum system is assumed, the information amount estimation step, includes a first process in which an upper limit of a variation distance between an approximation protocol (a protocol using a good-natured operator) that is relatively easy to analyze and an actual protocol (a protocol using a measurement operator including reception errors in actual situations), a second process in which the upper limit of a probability that the estimated value of error probability is estimated to be smaller than a true value when a basis that is opposite to the actual basis is used in the approximation protocol, a third process in which the upper limit of a conditional probability of the received data and intercepted information when the transmission data is set as a condition is calculated, a fourth process in which an amount of eavesdropping in the approximation protocol is calculated based on the upper limit of the probability that the estimated value of error probability is estimated to be smaller than the true value obtained in the second process and the upper limit of the conditional probability obtained in the third process, and a fifth process in which the amount of eavesdropping in the actual protocol is calculated based on the amount of eavesdropping in the approximation protocol and the upper limit of the variation distance obtained in the first process and its result is set as the amount of information leaked to the adversary through the quantum communication path.

Still another aspect of the present invention is the quantum key distribution method, wherein in the information amount estimation step, the amount of information held by the key is estimated based on characteristics of the quantum state generator provided to the first communication device or based on characteristics of the quantum state generator provided to the first communication device and a quantum state measuring apparatus provided to the second communication device and each communication device compresses data held by each communication device based on the estimated value of the amount of information held by the key and makes the data after compression a cryptographic key shared by each communication device.

Still another aspect of the present invention is the quantum key distribution method, wherein if a quantum system that is not necessarily two-level is assumed, a result of “non-detection” is assumed in addition to “0” and “1” as an observed value of the second communication device, further all transmission data is x[A], a portion of data of x[A] that can be detected by the second communication device is x[D], a portion of x[D] whose basis used on the sending side and that used on a receiving side is identical is x[C], partial data used in the error probability estimation step is x[R], and partial data for shared key generation (x[C]−x[R]) is x[K] (A, D, C, K, and R correspond to subsets showing bit positions), includes a first process in which a quantum state is decomposed into a portion containing a first density operator (corresponding to a portion L of the subset K) in a Hilbert space and a portion containing a second density operator (corresponding to a portion M (=K−L) of the subset K) so that the amount of information held by the key can be estimated to be as large as possible, a second process in which the amount of information held by the portion M is estimated, a third process in which the amount of information held by the portion L is estimated, and a fourth process in which the amount of information held by the portion K is calculated using the amount of information held by the portion M and that held by the portion L.

The quantum key distribution method according to still another aspect of the present invention, is being applicable to a quantum key distribution method using two non-orthogonal states.

A communication system according to still another aspect of the present invention is configured by a first communication device transmitting a quantum state specified by two random number sequences corresponding to a basis and data to a quantum communication path and a second communication device obtaining data by measuring the quantum state on the quantum communication path using the basis specified by the random number sequences to realize quantum key distribution in which the second communication device sets data obtained by measurement using the same basis as that of the first communication device as received data and the first communication device sets a random number sequence corresponding to the received data as transmission data, wherein the first communication device, includes a first shared key generation unit that extracts a predetermined number of pieces of first partial data from the transmission data, receives, on the other hand, second partial data (partial data extracted from the received data) at the same positions as those of the first partial data from the second communication device, estimates an error probability of data used for key generation based on a degree of matching (error probability) of both partial data, subsequently estimates an amount of information leaked to an adversary through a quantum communication path based on information of the estimated value of error probability and characteristics of a quantum state generator provided to the first communication device, and then makes the transmission data after compression based on the estimated value of the amount of information leaked to the adversary a cryptographic key shared by each communication device, and the second communication device, includes a second shared key generation unit that estimates the error probability of data used for key generation based on a degree of matching (error probability) of the second partial data and the first partial data received from the first communication device, subsequently estimates the amount of information leaked to the adversary through the quantum communication path based on the estimated value of error probability and information about characteristics of the quantum state generator provided to the first communication device, and then makes the received data after compression based on the estimated value of the amount of information leaked to the adversary a cryptographic key shared by each communication device.

Still another aspect of the present invention is the communication system, wherein the first and second shared key generation units estimate the amount of information leaked to the adversary through the quantum communication path based on the estimated value of error probability and information about characteristics of the quantum state generator provided to the first communication device and a quantum state measuring apparatus provided to the second communication device.

Still another aspect of the present invention is the communication system, wherein the first and second shared key generation units further perform determination processing based on predetermined determination information for determining whether the transmission data held by the first communication device and the received data held by the second communication device match and, if a result of the determination is a mismatch, performs processing to discard data held by each communication device, and in the determination processing, the first shared key generation unit determines first determination information of a specific bit length by calculating “a predetermined random matrix×the transmission data held by the first communication device” as the predetermined determination information and transmits the first determination information to the second communication device via a public communication path, the second shared key generation unit determines second determination information of the same bit length as that of the first determination information by calculating “the predetermined random matrix×the received data held by the second communication device” as the predetermined determination information and transmits the second determination information to the first communication device via the public communication path, subsequently, the first shared key generation unit determines whether the first determination information and the second determination information obtained from the second communication device match, and the second shared key generation unit, on the other hand, determines whether the second determination information and the first determination information obtained from the first communication device match.

A communication device according to still another aspect of the present invention, on a quantum state sending side that transmits a quantum state specified by two random number sequences corresponding to a basis and data to a quantum communication path and makes a random number sequence corresponding to data obtained by measurement using a same basis as that of the sending side by a communication device on a quantum state receiving side first transmission data, includes an error probability estimation function that extracts data at a predetermined number of bit positions from the first transmission data, notifies the communication device on the receiving side of partial data after extraction via a public communication path, subsequently estimates an error probability of data used for key generation based on a degree of matching (error probability) with partial data at the same bit positions obtained from the communication device on the receiving side, and further makes remaining data excluding the partial data made public second transmission data, an error correcting function that notifies the second communication device of predetermined error correcting information via the public communication path, compresses the second transmission data in accordance with an amount of the error correcting information made public, and makes the data after compression third transmission data, a matching determination function that notifies the communication device on the receiving side of determination information used for determining whether the third transmission data and data obtained from the communication device on the receiving side match via the public communication path and, if a determination result based on the determination information is a mismatch, discards the third transmission data and, if, on the other hand, the determination result is a match, compresses the third transmission data in accordance with an amount of the determination information made public before making the data after compression fourth transmission data, an estimation function that estimates the amount of information leaked to an adversary through the quantum communication path from the estimated error probability and information about characteristics of a source or a detector, and a shared key generation function that compresses the fourth transmission data based on the estimated value of the amount of information leaked to the adversary and makes the data after compression a cryptographic key shared by devices.

A communication device according to still another aspect of the present invention, on a quantum state receiving side that makes data obtained by measurement using a same basis as that on a quantum state sending side among data obtained by measurement using the basis specified by a random number sequence for a quantum state on a quantum communication path first received data, includes an error probability estimation function that extracts data at a predetermined number of bit positions from the first received data, notifies the communication device on the photon sending side of partial data after extraction via a public communication path, subsequently estimates an error probability of data used for key generation based on a degree of matching (error probability) with partial data at the same bit positions obtained from the communication device on the sending side, and further makes remaining data excluding the partial data made public second received data, an error correcting function that corrects errors of the second received data based on error correcting information obtained from the communication device on the sending side, compresses the second received data after error correction in accordance with an amount of the error correcting information made public by the communication device on the sending side, and makes the data after compression third received data, a matching determination function that notifies the communication device on the sending side of determination information used for determining whether the third received data and data obtained from the communication device on the sending side match via the public communication path and, if a determination result based on the determination information is a mismatch, discards the third received data and, if, on the other hand, the determination result is a match, compresses the third received data in accordance with an amount of the determination information made public before making the data after compression fourth received data, an estimation function that estimates the amount of information leaked to an adversary through the quantum communication path from the estimated error probability and information about characteristics of a source or a detector, and a shared key generation function that compresses the fourth received data based on the estimated value of the amount of information leaked to the adversary and makes the data after compression a cryptographic key shared by devices.

A communication device according to still another aspect of the present invention, on a sending side that transmits a quantum state specified by two random number sequences corresponding to a basis and data to a quantum communication path and makes a random number sequence corresponding to data obtained by measurement using a same basis as that of the sending side by a communication device on a quantum state receiving side first transmission data, includes an error probability estimation function that extracts data at a predetermined number of bit positions from the first transmission data, notifies the communication device on the receiving side of partial data after extraction via a public communication path, subsequently estimates an error probability of data used for key generation based on a degree of matching (error probability) with partial data at the same bit positions obtained from the communication device on the receiving side, and further makes remaining data excluding the partial data made public second transmission data, an error correcting function that notifies the second communication device of predetermined error correcting information via the public communication path, compresses the second transmission data in accordance with an amount of the error correcting information made public, and makes the data after compression third transmission data, a matching determination function that notifies the communication device on the receiving side of determination information used for determining whether the third transmission data and data obtained from the communication device on the receiving side match via the public communication path and, if a determination result based on the determination information is a mismatch, discards the third transmission data and, if, on the other hand, the determination result is a match, compresses the third transmission data in accordance with an amount of the determination information made public before making the data after compression fourth transmission data, an estimation function that estimates the amount of information held by a key based on characteristics of a quantum state generator or based on characteristics of the quantum state generator and a quantum state measuring apparatus provided to the communication device on the receiving side, and a shared key generation function that compresses the fourth transmission data based on the estimated value of the amount of information held by the key and makes the data after compression a cryptographic key shared by devices.

A communication device according to still another aspect of the present invention, on a quantum state receiving side that makes data obtained by measurement using a same basis as that on a quantum state sending side among data obtained by measurement using the basis specified by a random number sequence for a quantum state on a quantum communication path first received data, includes an error probability estimation function that extracts data at a predetermined number of bit positions from the first received data, notifies the communication device on the photon sending side of partial data after extraction via a public communication path, subsequently estimates an error probability of data used for key generation based on a degree of matching (error probability) with partial data at the same bit positions obtained from the communication device on the sending side, and further makes remaining data excluding the partial data made public second received data, an error correcting function that corrects errors of the second received data based on error correcting information obtained from the communication device on the sending side, compresses the second received data after error correction in accordance with an amount of the error correcting information made public by the communication device on the sending side, and makes the data after compression third received data, a matching determination function that notifies the communication device on the sending side of determination information used for determining whether the third received data and data obtained from the communication device on the sending side match via the public communication path and, if a determination result based on the determination information is a mismatch, discards the third received data and, if, on the other hand, the determination result is a match, compresses the third received data in accordance with an amount of the determination information made public before making the data after compression fourth received data, an estimation function that estimates the amount of information held by a key based on characteristics of a quantum state generator provided to the communication device on the sending side or based on characteristics of the quantum state generator and a quantum state measuring apparatus, and a shared key generation function that compresses the fourth received data based on the estimated value of the amount of information held by the key and makes the data after compression a cryptographic key shared by devices.

A communication device according to still another aspect of the present invention, on a sending side that transmits a quantum state specified by random number sequences corresponding to data to a quantum communication path and makes a random number sequence corresponding to a quantum state neither matching nor orthogonal to a measurement result in a communication device on a quantum state receiving side first transmission data, includes an error probability estimation function that extracts data at a predetermined number of bit positions from the first transmission data, notifies the communication device on the receiving side of partial data after extraction via a public communication path, subsequently estimates an error probability of data used for key generation based on a degree of matching (error probability) with partial data at same bit positions obtained from the communication device on the receiving side, and further makes remaining data excluding the partial data made public second transmission data, an error correcting function that notifies the second communication device of predetermined error correcting information via the public communication path, compresses the second transmission data in accordance with an amount of the error correcting information made public, and makes the data after compression third transmission data, a matching determination function that notifies the communication device on the receiving side of determination information used for determining whether the third transmission data and data obtained from the communication device on the receiving side match via the public communication path and, if a determination result based on the determination information is a mismatch, discards the third transmission data and, if, on the other hand, the determination result is a match, compresses the third transmission data in accordance with an amount of the determination information made public before making the data after compression fourth transmission data, an estimation function that estimates the amount of information held by a key based on characteristics of a quantum state generator or based on characteristics of the quantum state generator and a quantum state measuring apparatus provided to the communication device on the receiving side, and a shared key generation function that compresses the fourth transmission data based on the estimated value of the amount of information held by the key and makes the data after compression a cryptographic key shared by devices.

A communication device according to still another aspect of the present invention, on a quantum state receiving side that makes data corresponding to a measurement result neither matching nor orthogonal to a quantum state on the sending side among data obtained by measurement using a basis specified by a random number sequence for a quantum state on a quantum communication path first received data, includes an error probability estimation function that extracts data at a predetermined number of bit positions from the first received data, notifies the communication device on the photon receiving side of partial data after extraction via a public communication path, subsequently estimates an error probability of data used for key generation based on a degree of matching (error probability) with partial data at same bit positions obtained from the communication device on the sending side, and further makes remaining data excluding the partial data made public second received data, an error correcting function that corrects errors of the second received data based on error correcting information obtained from the communication device on the sending side, compresses the second received data after error correction in accordance with an amount of the error correcting information made public by the communication device on the sending side, and makes the data after compression third received data, a matching determination function that notifies the communication device on the sending side of determination information used for determining whether the third received data and data obtained from the communication device on the sending side match via the public communication path and, if a determination result based on the determination information is a mismatch, discards the third received data and, if, on the other hand, the determination result is a match, compresses the third received data in accordance with an amount of the determination information made public before making the data after compression fourth received data, an estimation function that estimates the amount of information held by a key based on characteristics of a quantum state generator provided to the communication device on the sending side or based on characteristics of the quantum state generator and a quantum state measuring apparatus, and a shared key generation function that compresses the fourth received data based on the estimated value of the amount of information held by the key and makes the data after compression a cryptographic key shared by devices.

### EFFECT OF THE INVENTION

According to the present invention, the error probability estimation step, error correcting step, matching determination step, and information amount estimation step are executed, further data is compressed based on the amount of information made public through a public communication path in a process of processing and an estimated value of the amount of information leaked to an adversary through a quantum communication path, and the data after compression is made an cryptographic key shared by devices. Particularly, the amount of information leaked to the adversary through the quantum communication path is estimated based on characteristics of a source and a detector. Accordingly, even in a realistic implementation, an effect of being able to efficiently generate a shared key whose security is highly ensured can be obtained.

### BRIEF DESCRIPTION OF DRAWINGS

FIG. 1 is a diagram showing a configuration of communication devices in a quantum cryptographic system according to the present invention;

FIG. 2-1 is a flow chart showing quantum key distribution of the present invention;

FIG. 2-2 is a flow chart showing quantum key distribution of the present invention;

FIG. 3 is a flow chart exemplifying a construction method of “Irregular-LDPC code” based on finite affine geometry;

FIG. 4 is a diagram showing a matrix of finite affine geometric code AG (2, 2²);

FIG. 5 is a diagram showing S_{A} generated by a syndrome generation part;

FIG. 6-1 is a diagram showing information M_{PC} x(n−k);

FIG. 6-2 is a diagram showing information M_{PC} y(n−k)′;

FIG. 7-1 is a diagram showing transmission data x′;

FIG. 7-2 is a diagram showing received data y′;

FIG. 8-1 is a diagram showing a cryptographic key r generated by a communication device on a sending side;

FIG. 8-2 is a diagram showing a cryptographic key r generated by a communication device on a receiving side; and

FIG. 9 is a diagram showing an outline of conventional quantum key distribution using polarization.

### EXPLANATIONS OF LETTERS OR NUMERALS

1, 3 Cryptographic key generation part
2, 4 Communication part
10, 30 Parity check matrix generation part
11, 31 Random number generation part
12 Photon generation part
13, 34 Public communication path communication part
14 Syndrome generation part
15, 35 Shared key generation part
21, 42 Encryption part
22, 41 Transmission/reception part
32 Photon reception part
33 Syndrome decoding part

### BEST MODES FOR CARRYING OUT THE INVENTION

Embodiments of the quantum key distribution method and communication device according to the present invention will be described below based on drawings. However, the present invention is not limited by such embodiments.

### First Embodiment

Quantum key distribution is a key distribution method with which security is ensured regardless of numeric abilities of an adversary, but it is necessary for example to remove data errors caused when passing through a transmission path to efficiently generate a shared key. Thus, in the present embodiment, quantum key distribution when the low-density parity-check (LDPC) code, that is known to have an extremely high level of characteristics, is used to correct errors will be described.

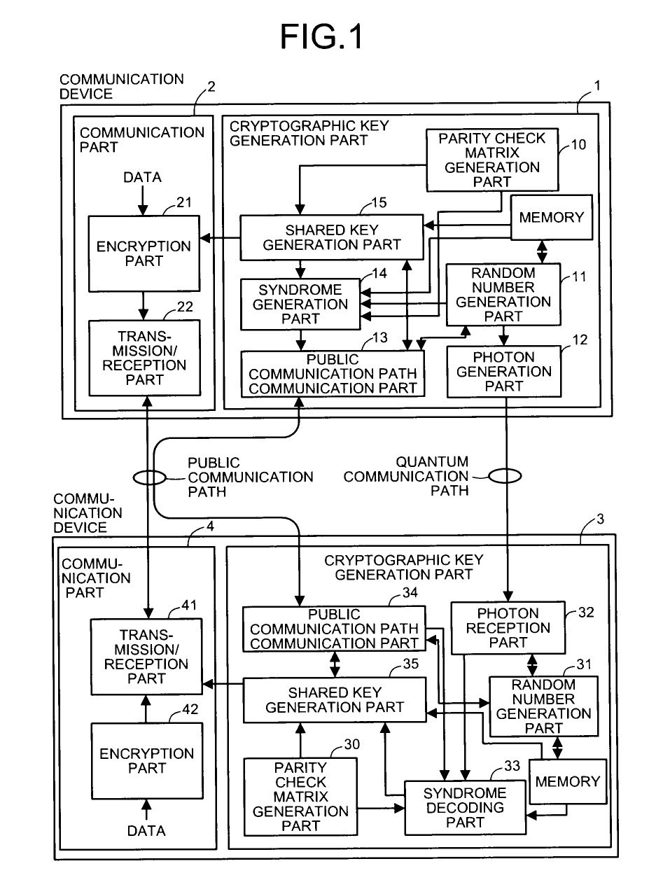

FIG. 1 is a diagram showing the configuration of communication devices (source, detector) in a quantum cryptographic system according to the present invention. The quantum cryptographic system is equipped with a communication device on the sending side having a function to transmit information x and a communication device on the receiving side having a function to receive the information after being affected by noise and the like on a transmission path, that is, information y.

Also, the communication device on the sending side comprises a cryptographic key generation part 1 that transmits the information x via a quantum communication path and further generates a cryptographic key (shared key with the receiving side) based on information transmitted and received via a public communication path and the amount of information (estimated amount) leaked to an adversary, and a communication part 2 in which a transmission/reception part 22 exchanges data encrypted by an encryption part 21 based on the cryptographic key via the public communication path, and the communication device on the receiving side comprises a cryptographic key generation part 3 that receives the information y via the quantum communication path and further generates a cryptographic key (shared key with the sending side) based on information transmitted and received via the public communication path and the amount of information (estimated amount) leaked to an adversary, and a communication part 4 in which a transmission/reception part 41 exchanges data encrypted by an encryption part 42 based on the cryptographic key via the public communication path.

The cryptographic key generation part 1 comprises a parity check matrix generation part 10, a random number generation part 11, a photon generation part 12, a public communication path communication part 13, a syndrome generation part 14, and a shared key generation part 15, and the cryptographic key generation part 3 comprises a parity check matrix generation part 30, a random number generation part 31, a photon reception part 32, a syndrome decoding part 33, a public communication path communication part 34, and a shared key generation part 35. The quantum state used for the cryptographic key generation parts 1 and 3 is not limited to states of polarization of photons and may be any quantum system as long as the system has two levels.

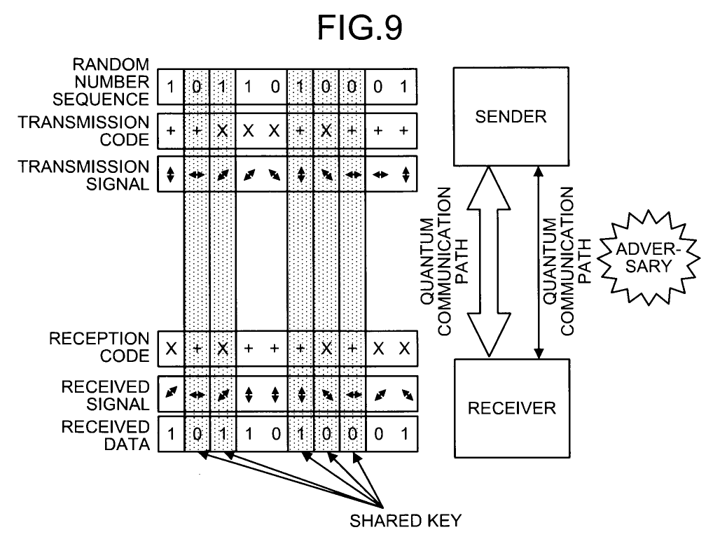

The communication device on the sending side transmits light polarized in a predetermined direction using a polarizing filter (See FIG. 9) to the communication device on the receiving side as the information x to be transmitted to the quantum communication path. In contrast, the communication device on the receiving side identifies light polarized in the horizontal direction 0°, light polarized in the vertical direction 90°, light polarized in the 45° direction, and light polarized in the 135° direction using a measuring apparatus that can identify polarized light in the horizontal and vertical directions (0°, 90°) and another measuring apparatus that can identify polarized light in the slanting directions (45°, 135°). Each measuring apparatus can recognize light polarized in specified directions correctly, but if, for example, light polarized in slanting directions is measured by a measuring apparatus that can identify polarized light in the horizontal and vertical directions (0°, 90°), light polarized in the horizontal direction and that polarized in the vertical direction will be identified randomly with a 50% probability each. That is, if a measuring apparatus that is not provided for identifiable polarization directions is used, the polarized direction cannot be correctly identified even if measurement results thereof are analyzed.

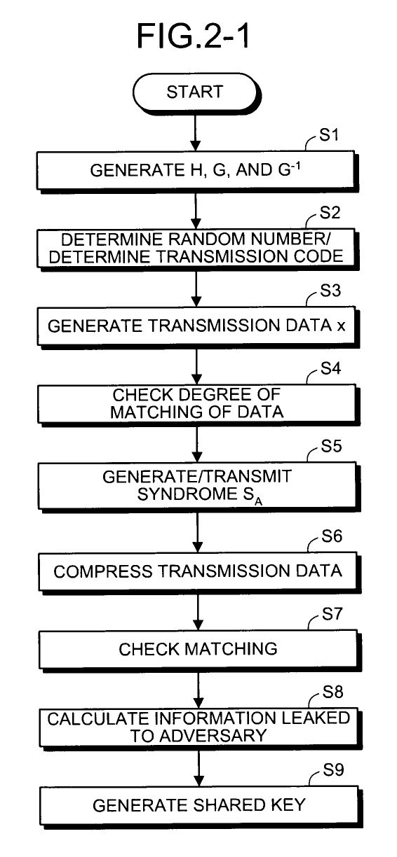

Operations of each communication device of the quantum cryptographic system, that is, quantum key distribution in the present embodiment will be described below. FIG. 2 depicts flow charts showing quantum key distribution in the present embodiment, and more specifically, FIG. 2-1 depicts processing of the communication device on the sending side and FIG. 2-2 depicts processing of the communication device on the receiving side.

In the communication device on the sending side and communication device on the receiving side, first the parity check matrix generation parts 10 and 30 determine a parity check matrix H (n columns×k rows) of a specific linear code, determine a generating matrix G ((n−k) columns×n rows) satisfying “HG=0” from the parity check matrix H, and further determine an inverse matrix G⁻¹ (n columns×(n−k) rows) satisfying G⁻¹·G=I (identity matrix) (step S1, step S11). In the present embodiment, quantum key distribution using the LDPC code having excellent characteristics extremely close to a Shannon limit as the specific linear code will be described. The LDPC code is used as an error correcting system in the present embodiment, but the present embodiment is not limited to this and may use another linear code such as a turbo code. Moreover, any matrix H may be used as long as linearity between error correcting information (syndrome) described later and the information x is ensured.

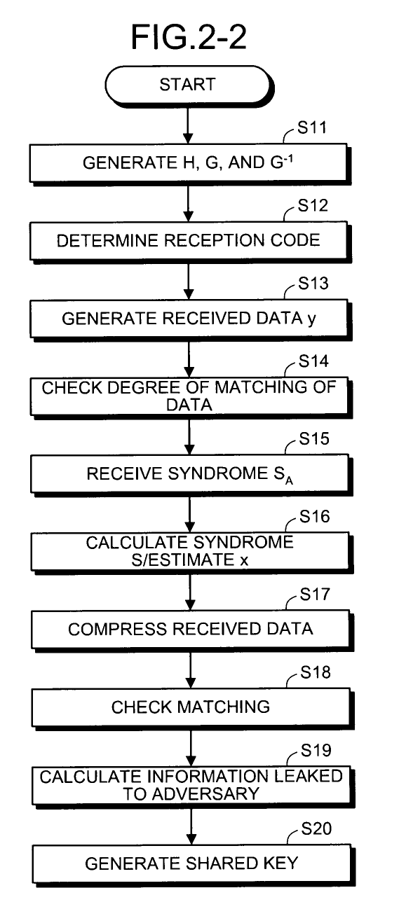

Here, the construction method of the LDPC code, more specifically, the construction method “Irregular-LDPC code” (example of step S1 in FIG. 2) based on finite affine geometry in the parity check matrix generation part 10 will be described. FIG. 3 is a flow chart exemplifying the construction method of “Irregular-LDPC code” based on finite affine geometry. The parity check matrix generation part 30 performs the same processing as that of the parity check matrix generation part 10 and thus, a description thereof is omitted. Check matrix generation processing in the present embodiment may be configured to be performed, for example, in the parity check matrix generation part 10 in accordance with parameters to be set or in another control device (such as a computer) outside the communication device. If check matrix generation processing in the present embodiment is performed outside the communication device, a generated check matrix is stored in the communication device. In embodiments that follow, cases in which check matrix generation processing is performed by the parity check matrix generation part 10 will be described.

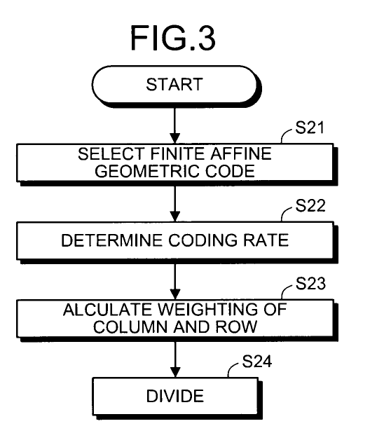

First, the parity check matrix generation part 10 selects a finite affine geometric code AG (2, 2^{s}), that serves as a base of the check matrix for “Irregular-LDPC code” (FIG. 3, step S21). Here, the weight of the row and that of the column are each 2^{s}. FIG. 4 is, for example, a diagram (A blank indicates 0) showing a matrix of finite affine geometric code AG (2, 2²). Next, the parity check matrix generation part 10 determines a coding rate (length of one syndrome/key length) (step S22).

Next, the parity check matrix generation part 10 determines a weighting of the column and that of the row after division (division to n columns×k rows) based on the coding rate using optimization by Gaussian approximation (step S23).

Lastly, the parity check matrix generation part 10 generates a n×k parity check matrix H by dividing the row and column in finite affine geometry based on the weightings determined above (step S24). At this point, division processing of the finite affine geometric code in the present embodiment is performed not by regularly dividing, but by randomly extracting the number “1” from each row or each column. The extraction processing may be performed by any method if randomness is maintained.

If, for example, the row numbers of “1” in one column in AG (2, 2⁵) are B₁ (x)={1 32 114 136 149 223 260 382 402 438 467 507 574 579 588 622 634 637 638 676 717 728 790 851 861 879 947 954 971 977 979 998}, the number “1” is randomly extracted from B₁ (x) for the first to fourth columns Rₘ (n) in a matrix after division, producing, for example,

R₁ (n)={1 114 574 637 851 879 977 979}

R₂ n)={32 136 402 467 588 728 861 971}

R₃(n)={149 260 382 438 579 638 717 998}

R₄(n)={223 507 622 634 676 790 947 954}

In the present embodiment, as described above, a deterministic check matrix H (n columns×k rows) for “Irregular-LDPC code” whose characteristics are stable is generated by performing the construction method of “Irregular-LDPC code” based on the finite affine geometry shown in FIG. 3.

After generating the parity check matrix H, generating matrix G, and G⁻¹ (G⁻¹·G=I: identity matrix), as has been described above, next in the communication device on the sending side, the random number generation part 11 generates a random number sequence (sequence of 1 and 0: transmission data) and further determines a transmission code (+: code corresponding to a measuring apparatus that can identify light polarized in the horizontal and vertical directions, x: code corresponding to a measuring apparatus that can identify light polarized in the slanting directions) randomly (step S2). In the communication device on the receiving side, on the other hand, the random number generation part 31 determines a reception code (+: code corresponding to a measuring apparatus that can identify light polarized in the horizontal and vertical directions, x: code corresponding to a measuring apparatus that can identify light polarized in the slanting directions) randomly (step S12).

Next, in the communication device on the sending side, the photon generation part 12 transmits photons in a polarization direction automatically determined by the combination of the random number sequence and transmission code (step S3). For example, light polarized in the horizontal direction by the combination of 0 and +, light polarized in the vertical direction by combining 1 and +, light polarized in the 45° direction by combining 0 and x, and light polarized in the 135° direction by combining 1 and x are each transmitted to a quantum communication path (transmission signal).

The photon reception part 32 of the communication device on the receiving side that has received an optical signal generated by the photon generation part 12 measures light on the quantum communication path (received signal). Then, received data automatically determined by the combination of the reception code and received signal is obtained (step S13). Here, 0 as the combination of light polarized in the horizontal direction and +, 1 as the combination of light polarized in the vertical direction and +, 0 as the combination of light polarized in the 45° direction and x, and 1 as the combination of light polarized in the 135° direction and x are each received as the received data.

Next, in the communication device on the receiving side, the random number generation part 31 transmits the reception code (basis) corresponding to the received data and locations where no photon could be detected to the communication device on the sending side via a public communication path in order to examine whether the above measurement is a measurement using the same basis as that of the sending side, that is, measurement has been made using a correct measuring apparatus (step S13). In the communication device on the sending side, after receiving the reception code, the random number generation part 11 examines whether measurement at locations on the receiving side where photons could be detected has been made using a correct measuring apparatus and transmits an examination result thereof to the communication device on the receiving side via the public communication path (step S3).

Then, in the communication device on the receiving side, the random number generation part 31 retains only received data measured using a correct measuring apparatus based on the above examination result and discards the rest (step S13). Also in the communication device on the sending side, the random number generation part 11 retains only transmission data corresponding to the received data measured using a correct measuring apparatus on the receiving side and discards the rest (step S3). Subsequently, data (transmission data x[C] and received data y[C]) corresponding to a set :C of remaining bit positions is stored in a memory or the like (y[C] is x[C] after being affected by noise or the like on a transmission path).

Next, in the communication device on the receiving side and communication device on the sending side, the degree of matching of the transmission data x[C] and the received data y[C] is checked (steps S4, S14). More specifically, first the shared key generation part 15 reads the transmission data x[C] and transmits bit positions (subset :R of bit positions randomly extracted from a set :C of bit positions of the transmission data x[C]) used for matching degree check to the communication device on the receiving side via the public communication path. The subset R may be made public by the communication device on the receiving side. At this point, the subset R is shared by the sending side and the receiving side. Then, the shared key generation part 15 transmits a portion of the transmission data x[C] corresponding to the subset R, that is, transmission data x[R] to the communication device on the receiving side via the public communication path.

The shared key generation part 35 of the communication device on the receiving side, on the other hand, transmits a portion of the received data y[C] corresponding to the subset R, that is, received data y[R] to the communication device on the sending side via the public communication path. Since the subset :R is made public, transmission data x[K] and received data y[K] corresponding to a remaining subset :K (=C−R) will be data for generating a shared key. In the present embodiment, if, for example, the subset R is made larger, accuracy of the matching degree check will improve, but the key length will be shorter. Conversely, if the subset R is made smaller, accuracy of the matching degree check will deteriorate, but the key length can be made longer.

Subsequently, the shared key generation part 15 compares the transmission data x[R] and the received data y[R] transmitted from the receiving side. An error probability P_{R}=nₑ/n_{R} of the received data y[R] when, for example, the number of bit positions of the subset R is n_{R} (the number of remaining bit positions is n_{K}) and the number of pieces of data (number of errors) that do not match as a result of comparison is nₑ is determined. The shared key generation part 35, on the other hand, compares the received data y[R] and the transmission data x[R] transmitted from the sending side and, just like the above case, determines the error probability P_{R}=nₑ/n_{R} of the received data y[R]. At this point, the error probability P_{R} is shared by the sending side and the receiving side.

Then, the shared key generation part 15 calculates, as a final result of the matching degree check, for example, an estimated value P′ of the error probability P_{K} in the subset K based on the above error probability P_{R} according to the following formula (1). Here, a security parameter δₚ is introduced.

P⁺=P_{R}+(n_{R}+n_{K})δₚ/nₖ (1)

At this point, an upper limit εₚ of a probability Pr [P⁺≦P_{K}] that the estimated value P⁺ of the error probability is estimated to be smaller than the real value P_{K} is given by the following formula (2) using the security parameter δₚ. It is sufficient for the following upper limit εₚ to be only an upper limit of a probability that the estimated value P⁺ is estimated to be smaller than the real value P_{K} and its form is not limited to the following formula (2). This also applies to εₛ shown below.

εₚ=exp(−2n_{R}(δₚ)²)≧Pr[P⁺≧P_{K}] (2)

If error estimations and error corrections are performed simultaneously, for example, a family of appropriate linear codes is configured and appropriate decoding by additional syndrome processing is performed. In such a case, the formulas for calculating P⁺ and εₚ are replaced by the following formula (3):

P⁺=P_{R}

εₚ=0 (3)

where R=K=C and n_{R}=n_{K}.

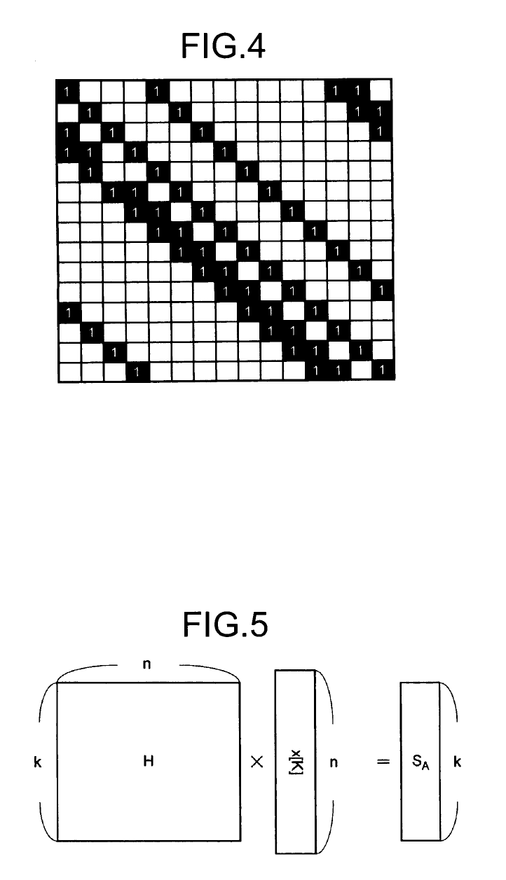

Next, in the communication device on the sending side, the syndrome generation part 14 calculates a syndrome S_{A}=Hx[K] of the transmission data x[K] using the parity check matrix H (n columns×k rows) and x[K] and notifies the communication device on the receiving side of a result thereof via the public communication path (step 5S). FIG. 5 is a diagram showing S_{A} generated by the syndrome generation part 14. In this stage, the syndrome S_{A} (information for k bits) of x[K] may be leaked to an adversary. In the communication device on the receiving side, on the other hand, the public communication path communication part 34 receives the syndrome S_{A} of x[K] and notifies the syndrome decoding part 33 of the syndrome S_{A} (step S15).

The syndrome decoding part 33 calculates a syndrome S_{B}=Hy[K] of the received data y[K] using a parity check matrix H generated in advance and y[K] and further calculates a syndrome S=S_{A}+S_{B} using the syndrome S_{A} of x[K] and the syndrome S_{B} of y[K]. Then, transmission data x[K] is estimated based on the syndrome S. That is, received data y[K]′ after error correction is determined (step S16). Here, it is assumed that

y[K]=x[K]+e(noise and the like) (4)

and after transformation of the syndrome S as shown in the following formula (5), e is determined by syndrome decoding to estimate transmission data. Meanwhile, + in the following formula (5) denotes exclusive OR (XOR).

$$\begin{matrix}S = {S}_{A} + {S}_{B} \\ = Hx [ K ] + Hy [ K ] \\ = H ( x [ K ] + y [ K ] ) \\ = H ( x [ K ] + x [ K ] + e ) \\ = He\end{matrix} \qquad ( 5 )$$

Next, in the communication device on the receiving side, the shared key generation part 35 discards a portion of the received data y[K]′ in accordance with the error correcting information (information :S_{A} for the k bits that could have been intercepted) made public by processing in the above steps S5 and S15 to generate received data y(n−k)′ having the length of (n−k) bits (step S17). That is, the shared key generation part 35 generates the received data y(n−k)′ according to the following formula (6) using G⁻¹(n×(n−k)) calculated in advance.

y(n−k)′=G⁻¹y[K]′ (6)

In the communication device on the sending side, on the other hand, the shared key generation part 15 also discards a portion of the transmission data x[K] in accordance with the error correcting information (information :S_{A} for the k bits that could have been intercepted) made public before generating transmission data x(n−k) having the length of (n−k) bits (step S6). That is, the shared key generation part 15 generates the transmission data x(n−k) according to the following formula (7) using G⁻¹(n×(n−k)) calculated in advance.

x(n−k)=G^{31 1}x[K] (7)

Next, in the communication device on the sending side and communication device on the receiving side, whether the transmission data x(n−k) and the received data y(n−k)′ match is checked (step S7, step S18). More specifically, first the shared key generation parts 15 and 35 determine a security parameter :s. The security parameter :s (corresponding to the bit length made public in this step) is a value determined in accordance with security required by a system. If the security parameter :s is a fixed value, it is stored by both sides, and if the security parameter :s is a variable value, it is made public each time by one side to the other side. If the security parameter s is large, security improves, though the key length will be shorter. Conversely, if the security parameter s is small, the key length can be made longer, though security will deteriorate.

If, for example, one of the shared key generation parts generates a random matrix M_{PC} of (n−k) columns×s rows and transmits the random matrix M_{PC} to the other communication device via the public communication path. At this point, the random matrix M_{PC} is shared by the sending side and the receiving side. Further, each shared key generation part determines a generating matrix G(M_{PC}) of (n−k) columns×(n−k−s) rows satisfying “M_{PC}·G(M_{PC})=0” from the random matrix M_{PC} and further determines an inverse matrix G⁻¹ (M_{PC}) of G (M_{PC}) satisfying G⁻¹ (M_{PC})·G(M_{PC})=I (identity matrix) (G⁻¹ (M_{PC}) is a matrix of (n−k) columns×(n−k−s) rows).

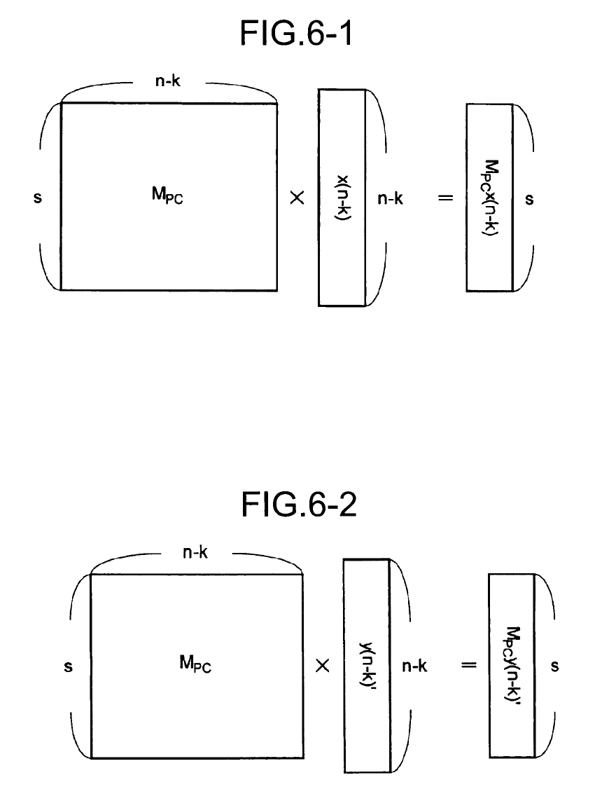

Then, the shared key generation part 15 calculates “random matrix M_{PC}×transmission data x(n−k)” and transmits information M_{PC} x(n−k) for the security parameter s bits to the communication device on the receiving side via the public communication path. FIG. 6-1 is a diagram showing the information M_{PC} x(n−k). The shared key generation part 35, on the other hand, calculates “random matrix M_{PC}×received data y(n−k)′” and transmits information M_{PC} y(n−k)′ for the security parameter s bits to the communication device on the sending side via the public communication path. FIG. 6-2 is a diagram showing the information M_{PC} y(n−k)′.

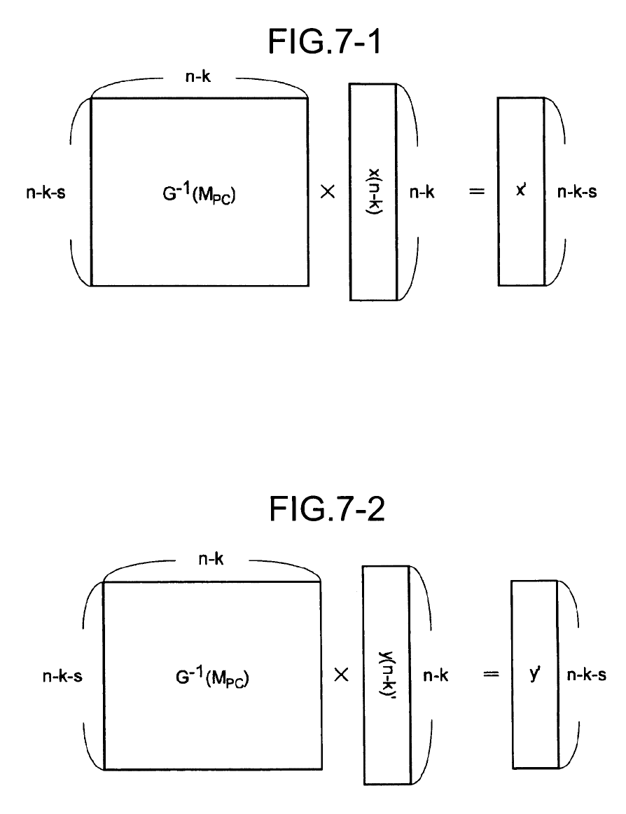

Subsequently, the shared key generation part 15 checks whether the information M_{PC} y(n−k)′ obtained from the communication device on the receiving side and the information M_{PC} x(n−k), that is a result of the above calculation, match. If they match, the shared key generation part 15 performs a calculation of the following formula (8) and compresses the transmission data x(n−k). That is, transmission data x′ of (n−k−s) bits after compression is obtained. FIG. 7-1 is a diagram showing the transmission data x′. Meanwhile, if they do not match, the transmission data x(n−k) is discarded.

x′=G⁻¹(M_{PC})x(n−k) (8)

Also, the shared key generation part 35 checks whether the information M_{PC} x(n−k) obtained from the communication device on the sending side and the information M_{PC} y(n−k)′, that is a result of the above calculation, match. If they match, the shared key generation part 35 performs a calculation of the following formula (9) and compresses the received data y(n−k)′. That is, received data y′ of (n−k−s) bits after compression is obtained. FIG. 7-2 is a diagram showing the received data y′. Meanwhile, if they do not match, the received data y(n−k)′ is discarded.

y′=G⁻¹(M_{PC})y(n−k)′ (9)

In the present embodiment, a probability ε_{c} that the received data y(n−k)′ and the transmission data x(n−k) after error correction do not match even if they match in the above check can be expressed as follows:

ε_{c}=2^{-s} (10)

If s is large, the probability decreases and, if s is small, the probability increases.

Next, in the communication device on the sending side and communication device on the receiving side, (the upper limit of) an amount of information I_{E} leaked to an adversary through a quantum communication path is estimated (step S8, step S19). Here, the amount of information I_{E} leaked to an adversary (an estimated value of the amount of information leaked through the quantum communication path) may be calculated by both the communication device on the sending side and communication device on the receiving side, or I_{E} may be calculated by the communication device on the sending side before a result thereof is made public to the receiving side. Particularly, a case in which I_{E} is calculated by both sides will be described below.

In the communication device on the sending side, the shared key generation part 15 calculates the amount of information leaked to an adversary through a quantum communication path based on the estimated value of error probability and information about characteristics of a quantum state generator provided to the communication device on the sending side. First, an approximation protocol (a protocol with which a good-natured quantum state is output from a source) that is relatively easy to analyze is considered and the upper limit of a difference (variation distance) in the measurement result of the actual protocol and the approximation protocol is calculated. Further, the upper limit of a probability that the estimated value of error probability is estimated to be smaller than a true value when a basis that is opposite to an actual basis regarding the position corresponding to the subset K is used in the approximation protocol is calculated. In addition, the upper limit of a conditional probability of received data and intercepted information when transmission data is set as a condition regarding the position corresponding to the subset K is calculated. Using these values, the upper limit of the amount of information leaked to an adversary in the end is calculated.

Here, calculation processing of the amount of information leaked to an adversary through a quantum communication path will be described. First, quantum states (source states including source errors) of photons actually output from a source and polarized in the 0°, 90°, 45°, and 135° directions are denoted by ρ₀₀, ρ₀₁, ρ₁₀, and ρ₁₁ respectively. These quantum states ρ₀₀, ρ₀₁, ρ₁₀, and ρ₁₁ are made public to the communication device on the receiving side in advance. However, if I_{E} is calculated by the communication device on the sending side and then a result thereof is made public to the communication device on the receiving side, there is no need to make the quantum states ρ₀₀, ρ₀₁, ρ₁₀, and ρ₁₁ public.

Let probabilities that the bases 0 (0°, 90° basis) and 1 (45°, 135° basis) are selected by the source be denoted by p_{b} (0) and p_{b} (1) respectively. Furthermore, let probabilities that data 0 and 1 are selected in the source be denoted by p_{X} (0) and p_{X} (1) respectively. If an ideal source is used, these four values are all ½.

Quantum states ρ₀₀, ρ₀₁, ρ₁₀, and ρ₁₁ that satisfy the following equation (11) and minimize Δ₀ and Δ₁ in the following equation (12) are selected. I in the following formulas denotes the identity operator in the two-dimensional Hilbert space.

(σ₀₀)²=σ₀₀,(σ₀₁)²=σ⁰¹,σ₀₀+σ₀₁=I

(σ₁₀)²=σ₁₀,(σ₁₁)²=σ₁₁,σ₁₀+σ₁₁=I (11)

Δ₀=d((½)ρ₀₀−(½)σ₀₀)+d((½)ρ₀₁−(½)σ₀₁)

Δ₁=d((½)ρ₁₀−(½)σ₁₀)+d((½)ρ₁₁−(½)σ₁₁) (12)

where d(A) in the above formula (11) denotes a trace norm of an operator A. That is, d(A) is calculated by the following formula (13) where a superscript * denotes complex conjugate transposition.

d(A)=Tr(√(A*A)) (13)

Let a random number of n_{K} bits corresponding to the basis used for the subset K be denoted by a. An upper limit ε_{K} of a difference (variation distance) of measurement results when quantum states σ₀₀, σ₀₁, σ₁₀, and σ₁₁ are used instead of the quantum states ρ₀₀, ρ₀₁, ρ₁₀, and ρ₁₁ is calculated by the following formula (14) using the above Δ₀ and Δ₁, where n₀ denotes the number of 0 in a, n₁ denotes the number of 1 in a, and ΔK denotes the upper limit of a variation distance between probability distribution p_{K} (x [K]) generating a bit string x[K] and uniform distribution.

ε_{K}=n₀Δ₀+n₁Δ₁+Δ_{K} (14)

Let a string obtained by bit-by-bit inversion of the bit string a be denoted by a′. Let the probability that the bit string a is generated according to the probability distribution p_{b} be denoted by p_{b} (a) and the probability that the bit string a′ is generated be denoted by p_{b}(a′). An upper limit ω_{K} of a probability that the estimated value P⁺ of a corresponding error probability is estimated to be smaller than a true value P_{K} when the quantum states σ₀₀, σ₀₁, σ₁₀, and σ₁₁ are used instead of the quantum states ρ₀₀, ρ₀₁, ρ₁₀, and ρ₁₁ and further an inverted basis a′ is used instead of the basis a is calculated according to the following formula (15).

ω_{K}=2ε_{K}p_{b}(a)/p_{b}(a′) (15)

Also, an average quantum state ρ₀ corresponding to the basis 0 (0°, 90° basis) output from the source and an average quantum state ρ₁ corresponding to the basis 1 (45°, 135° basis) are calculated by the following formulas (16) and (17):

ρ₀=p_{X}(0)ρ₀₀+p_{X}(1)ρ₀₁ (16)

ρ₁=p_{X}(0)ρ₁₀+p_{X}(1)ρ₁₁ (17)

Further, a parameter q determined by the quantum states σ₀₀, σ₀₁, σ₁₀, and σ₁₁ s calculated by the following formula (18):

q=max(Trσ₀₀σ₁₀,TRσ₀₀σ₁₁) (18)

Using the parameter q, an upper limit π_{K} of a conditional probability of received data and intercepted information when transmission data is set as a condition regarding the position corresponding to the subset K is calculated by the following formula (19).

π_{K}=2^{nk(h(P+)+log(q))} (19)

where log in the above formula (19) denotes a logarithmic function using base 2 and h(p) is calculated by the following formula (20):

h(p)=−p log(p)−(1−p)log(1−p) (20)

An amount of eavesdropping I_{Q} leaked to an adversary under the assumption that the quantum states σ₀₀, σ₀₁, σ₁₀, and σ₁₁ are used is calculated according to the following formula (20), where c is a real number greater than 0 and is selected so as to make the following formula (21) as small as possible:

I_{Q}=n_{K}+(1−1/c)(log(π_{K})−2 log(1−(√(cω_{K})) (21)

Further, an amount of eavesdropping I_{E} leaked to an adversary in an actual situation in which the quantum states ρ₀₀, ρ₀₁, ρ₁₀, and ρ₁₁ are used is calculated according to the following formula (22):

I_{E}=I_{Q}+ε_{K}(3n_{K}−2 log ε_{K}) (22)

It is sufficient for the above formula (22) to be only an upper limit to the amount of eavesdropping in an actual protocol when the amount of eavesdropping leaked to an adversary in an approximation protocol is I_{Q} and its form is not limited to the form shown above.

It may not always be possible to determine characteristics of a source with a probability of 1 in an actual implementation. For example, the source may not always be able to emit single photons. Thus, focusing on a set of parameters ρ₀₀, ρ₀₁, ρ₁₀, ρ₁₁, p_{b}(0), p_{b}(1), p_{X}(0), and p_{X}(1) denoting characteristics of the source, a situation in which the set of these parameters is included in a set S with a probability of 1−eₛ or more is assumed. Here, the security parameter εₛ is used to calculate a parameter e⁺ according to the following formula (24):

e⁺=eₛ+δₛ (24)

At this point, an upper limit εₛ of a probability that the number of times n that the source transmits a state that has not been assumed is smaller than n⁺=e⁺n_{K} in the subset K can be calculated by the following formula (25):

εₛ=exp(−2n_{K}(δₛ)²)≧Pr[n⁺≧nₛ] (25)

Assume that the number of times that the sources transmits a state that has not been assumed in the subset K is given by the above n⁺. At this point, a subset corresponding to the position where the source is transmitting an assumed state in the subset K is denoted by L. The length of the subset L is n_{L}=n_{K}−n⁺. Further, a random number of n_{L} bits corresponding to the basis used for the subset L is denoted by a_{L} and a string obtained by bit-by-bit inversion of a_{L} is denoted by a_{L}′. Like ε_{K} in the formula (14), ε_{L} is calculated by the following formula (26), where m₀ denotes the number of 0 in a_{L} and m₁ denotes the number of 1 in a_{L}. Also, ΔL denotes the upper limit of a variation distance between a probability distribution p_{X}(x[L]) generating a bit string x[L] and uniform distribution in the subset L.

ε_{L}=M₀Δ₀+m₁Δ₁+Δ_{L} (26)

ω_{L} and π_{L}, are calculated by the following formulas (27) and (28) instead of the formulas (15) and (19), where max_{L} denotes maximization regarding the subset L when the length n_{L} is fixed.

ω_{L}=max_{L}{2ε_{L}p_{b}(a_{L})/p_{b}(a_{L}′)} (27)

π_{L}=2^{nL(h((nK/nL)P+)+log(q))} (28)

If it is difficult to perform a maximization calculation regarding the above L, an upper limit may be used instead of the maximum value. It is sufficient for input “(n_{K}/n_{L})P⁺” into the function h in the formula (28) to be only an upper limit of error probability of the subset L and its form is not limited to the above form. If, for example, an occurrence of error in the subset K is independent of whether the source operates as assumed, the input may be replaced by “P_{R}+(n_{R}/n_{L})ε_{P}/n_{L}”.

I_{Q}′ and I_{E}′ are calculated according to the following formulas (29) and (30) instead of the formulas (21) and (22).

I_{Q}′=n_{L}+(1−1/c)(log(π_{L})−2 log(1−(√(cω_{L})))) (29)

I_{E}′=I_{Q}′+ε_{L}(3n_{L}−2 log ε_{L}) (30)

Meanwhile, it is sufficient for the formula (30) to be only an upper limit of the amount of eavesdropping in an actual protocol when the upper limit of the amount of eavesdropping of an approximation protocol regarding the subset L is I_{Q}′ and its form is not limited to the above form.

Further, the amount of eavesdropping I_{E} leaked to an adversary is calculated according to the following formula (31), where I_{M}′=n⁺.

I_{E}=I_{E}′+I_{M}′ (31)

Meanwhile, it is sufficient for I_{M}′ to be only an upper limit of the amount of information that can be obtained by an adversary from source states that have not been assumed.

Lastly, the amount of eavesdropping I_{E} in the above formula (31) is maximized regarding the set S to make the obtained maximum value the amount of eavesdropping to be determined. If it is difficult to perform a maximization calculation regarding the above S, an upper limit may be used instead of the maximum value.

Next, a case in which the amount of information leaked to an adversary through a quantum communication path is estimated based on the estimated value of error probability and information about characteristics of a quantum state generator provided to the communication device on the sending side and a quantum state measuring apparatus provided to the communication device on the receiving side will be described below. First, operators corresponding to measurement (measurement including detector errors) in the 0°, 90°, 45°, and 135° directions made by a detector are denoted by E₀₀, E₀₁, E₁₀, and E₁₁. Also, upper limits of trace norm of differences from a complete mixed state of an average quantum state corresponding to the basis 0 and that corresponding to the basis 1 output from the source are denoted as ∇₀ and ∇₁ respectively. That is, the following equations (32) and (33) are assumed to hold for ∇₀ and ∇₁ respectively:

d(ρ₀−(½)I)≦∇₀ (32)

d(ρ₁−(½)I)≦∇₁ (33)

Further, operators F₀₀, F₀₁, F₁₀, and F₁₁, corresponding to measurement that satisfy the following equation (34) and minimize Δ₀ and Δ₁ in the following equation (35) are selected, where I denotes the identity operator in the two-dimensional Hilbert space.

(F₀₀)²=F₀₀,(F₀₁)²=F₀₁,F₀₀+F₀₁=I

(F₁₀)²=F₁₀,(F₁₁)²=F₁₁,F₁₀+F₁₁=I (34)

Δ₀=d((½)E₀₀−(½)F₀₀)+d((½)E₀₁−(½)F₀₁)

Δ₁=d((½)E₁₀−(½)F₁₀)+d((½)E₁₁−(½)F₁₁) (35)

Particularly, if the above Δ₀ and Δ₁ are 0, Δₚ that satisfies the following equation (36) can be used as the above ∇₀ and ∇₁. That is, if Δ₀=Δ₁=0, Δₚ can be set as ∇₀=∇₁=Δₚ using Δₚ in the following equation (36):

d(ρ₀−ρ₁)≦Δₚ (36)

ε_{K}, q, and ε_{L} are calculated according to the following formulas (37), (38), and (39) instead of the formulas (14), (18), and (26).

ε_{K}=n₀,(Δ₀+Δ₀)+n₁(Δ₁+Δ₁)+Δ_{K} (37)

q=max{TrF₀₀F₁₀,TrF₀₀F₁₁} (38)

ε_{L}=mₙ(Δ₀+Δ₀)+m₁(Δ₁+Δ₁)+Δ₁ (39)

Using the above ε_{K}, q, and ε_{L}, the amount of eavesdropping I_{E} is calculated like the formula (22) or (31).

In general, the longer the length of code (n_{K} in the present embodiment), the better error correcting characteristics. In contrast, the amount of eavesdropping I_{E} does not necessarily become better with longer n_{K}. Thus, by changing the length of bit string for estimating the length of code and the amount of eavesdropping I_{E} for error correction, a quantum key distribution method of a higher level of characteristics can be configured. That is, the subset K is divided into a predetermined number of subsets to calculate the amount of eavesdropping I_{E} for each of the divided subsets. Here, the division number is selected so that a total of the amount of eavesdropping I_{E} for each divided subset can be minimized.

In the present embodiment, the amount of eavesdropping I_{E} leaked to an adversary is also calculated in the communication device on the receiving side by the same processing as described above.

Next, in the communication device on the sending side and communication device on the receiving side, based on the amount of information I_{E} calculated in processing of the above steps S8 and S19, portions of the transmission data x′ and received data y′ are discarded to generate a cryptographic key r having the amount of information for (n−k−s−T−v) bits (step S9, step S20). The shared key generation parts 15 and 35 determine a security parameter :v as a margin of the above amount of information I_{E}. The security parameter v is a value determined in accordance with security required by a system. If the security parameter v is large, security improves, though the key length will be shorter. Conversely, if the security parameter v is small, the key length can be made longer, though security will deteriorate. The above T denotes the smallest integer that is equal to or greater than the amount of information I_{E} leaked to an adversary that is determined above.

More specifically, the shared key generation part 15 randomly selects, for example, an element Hᵤ from a family of universal hash functions causing {0, 1}^{n-k-s}→{0, 1}^{n-k-s-T-v}. This can be realized, for example, by fetching a random matrix of full rank (rank(Hᵤ)=n−k−s−T−v) as Hᵤ. Then, the hash function Hᵤ is transmitted to the communication device on the receiving side via the public communication path. This processing may be performed by the shared key generation part 35 in the communication device on the receiving side.

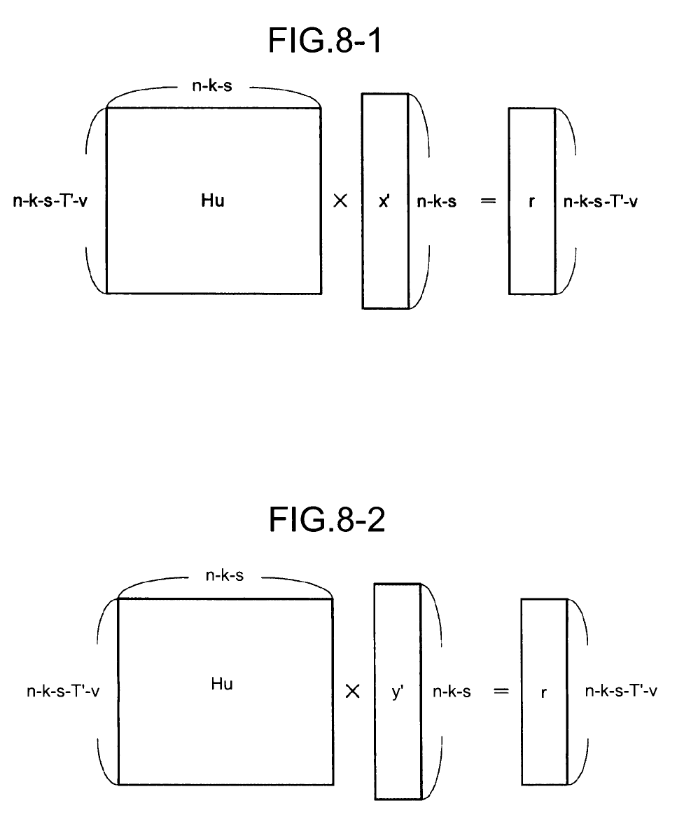

Then, the shared key generation part 15 generates the cryptographic key r according to the following formula (40) using the above Hᵤ. FIG. 8-1 is a diagram showing the cryptographic key r generated by the shared key generation part 15. The communication device on the sending side makes this cryptographic key r a shared key with the communication device on the receiving side.

r=Hᵤx′ (40)

The shared key generation part 35, on the other hand, generates the cryptographic key r according to the following formula (41) using the above Hᵤ. FIG. 8-2 is a diagram showing the cryptographic key r generated by the shared key generation part 35. The communication device on the receiving side makes this cryptographic key r a shared key with the communication device on the sending side.

r=Hᵤy′ (41)

Compression in steps S6 and S17 and that in steps S9 and S20 are performed separately in the above description, but the present embodiment is not limited to this and, for example, after generating the random matrix Hᵤ causing {0, 1}^{n-k-s}→{0, 1}^{n-k-s-T-v}, the above formulas (40) and (41) may be performed.

In the present embodiment, as described above, while correcting data errors of shared information using a deterministic parity check matrix for “Irregular-LDPC code” whose characteristics are stable, the above steps S4 and S14, the above steps S7 and S18, and the above steps S8 and S19 are performed, further data is compressed in accordance with the amount of information made public via the public communication path in a process of the above processing and estimated value of the amount of information leaked to an adversary through the quantum communication path, and the data after compression is made a cryptographic key shared by devices. Accordingly, a shared key whose security is ensured at a high level can efficiently be generated. That is, a quantum key distribution method whose success probability is (1−εₚ) (1−εₛ) (1−ε_{c}) or higher and the amount of information leaked to an adversary is (2^{-v}/ln 2) or less can be realized. However, if source states that are not assumed should not be considered, εₛ=0.

### Second Embodiment

Next, a second embodiment will be described. In the second embodiment, quantum states to be used are not limited to two-level states and a situation in which, in addition to “0” and “1”, a result of “non-detection” is allowed as an observed value of the communication device on the receiving side is considered. Thus, let all transmission data be denoted by x[A] and a portion of data of x[A] that can be detected by the receiving side be denoted by x[D]. x[C], x[R], and x[K] have the same meanings as above. In the communication device on the sending side and communication device on the receiving side, (a lower limit of) an amount of information R_{X} held by a key (transmission data x[K]) in consideration of information leaked to an adversary through a quantum communication path is estimated (corresponding to step S8 and step S19). Here, the amount of information R_{X} held by a key may be calculated by both the communication device on the sending side and communication device on the receiving side, or may be calculated by the communication device on the sending side before a result thereof is made public to the receiving side. Particularly, a case in which R_{X} is calculated by both sides will be described below.

Quantum states (source states including source errors) of photons actually output from a source and polarized in the 0°, 90°, 45°, and 135° directions are denoted by ρ₀₀, ρ₀₁, ρ₁₀, and ρ₁₁ respectively. Here, each quantum state is assumed to be a density operator in the Hilbert space H. Also, each quantum state is assumed to be output with a probability of ρ₀₀, ρ₀₁, ρ₁₀, and ρ₁₁ respectively. The quantum states ρ₀₀, ρ₀₁, ρ₁₀, and ρ₁₁ are made public to the communication device on the receiving side in advance. However, if R_{X} is calculated by the communication device on the sending side and then a result thereof is made public to the communication device on the receiving side, there is no need to make these values public.

In the communication device on the sending side, a quantum state ρᵢⱼ (i and j are either 0 or 1) is decomposed as shown in the following equation (42):

ρᵢⱼ=pᵢⱼ⁽⁰⁾ρᵢⱼ⁽⁰⁾+pᵢⱼ⁽¹⁾ρᵢⱼ⁽¹⁾ (42)

where ρᵢⱼ⁽⁰⁾ and ρᵢⱼ⁽¹⁾ are density operators in the Hilbert space H and satisfy the following equation (43):

0<p⁽⁰⁾≦min{pᵢⱼ},pᵢⱼ⁽⁰⁾=p⁽⁰⁾/pᵢⱼ,pᵢⱼ⁽⁰⁾+pᵢⱼ⁽¹⁾=1 (43)

This decomposition is determined so that the amount of information (Renyi entropy) R_{X} held by a key can be estimated to be as large as possible or the final amount of information (mutual information) held by a key (after compression) can be estimated to be as small as possible.

If, for example, ρᵢⱼ^{(o)} is selected to be as close to a two-level quantum state as possible and pᵢⱼ⁽⁰⁾ is selected to be as large as possible, R_{X} can generally be estimated to be large. In the following, the source is assumed to output ρᵢⱼ⁽⁰⁾ with a probability of pᵢⱼ⁽⁰⁾ and ρᵢⱼ⁽¹⁾ with a probability of pᵢⱼ⁽¹⁾.

X and Y are assumed to take four values of 00, 01, 10, and 11. Let spectral decomposition of the above quantum state ρₓ⁽⁰⁾ be

$${ρ}_{x}^{( 0 )} = {\sum }_{kX} {λ}_{X} ( {k}_{X} ) \vert {k}_{X} > < {k}_{X} \vert \qquad ( 44 )$$

and μ_{XY} be a map from a set {k_{z}} to a set {k_{y}}.

Further, |φ_{KX}> is assumed to be an element of an appropriate Hilbert space. Here, a 4×4 Gram matrix G is calculated by the following formula (45):

$${G}_{XY} = {\sum }_{kX} < {k}_{X} \vert {k}_{XY} > < {ϕ}_{kX} \vert {ϕ}_{kXY} > \sqrt{ } ( {λ}_{X} ( {k}_{X} ) {λ}_{Y} ( {k}_{XY} ) ) \qquad ( 45 )$$

where k_{XY}=μ_{XY}(k_{X}). μ_{XY} and |φ_{KX}> are selected so that the amount of information R_{X} held by a key can be estimated to be as large as possible

Since the Gram matrix G is positive semidefinite, a square matrix C of fourth order exists and the following equation (46) holds:

G=C*C (46)

Further, since the diagonal element of G is 1, a column vector of the matrix C can be considered to be an element of length 1 in the four-dimensional Hilbert space H₄. Thus, a quantum state σ_{X}′ (X=00, 01, 10, or 11) in H₄ is defined by the following equation (47):

σₓ′=|Cₓ><C_{X}| (47)

where C_{X} represents the X-th column of the matrix C. With this construction method of σ_{X}′, the existence of a completely-positive map from σ_{X}′ to ρₓ⁽⁰⁾ is assured. Thus in the following, σ_{X}′ is considered to be output, instead of ρₓ⁽⁰⁾.

Let a two-dimensional Hilbert subspace of the four-dimensional Hilbert space H₄ be H₂. σ_{X} (X=00, 01, 10, or 11) is assumed to be a quantum state in the Hilbert space H₂ satisfying the following equation (48), where I represents the identity operator in the Hilbert space H₂.

σ₀₀+σ₀₁=I,σ₁₀+σ₁₁=I (48)

The Hilbert space H₂ and the quantum state σ_{X} as are selected so that Δ_{X} (X=00, 01, 10, or 11) defined by the following equation (49) or its upper limit is minimized, where d(ρ, σ) represents a trace distance between ρ and σ.

Δ_{X}=d(σ_{X}′,σ_{X}) (49)

Minimization of the trace distance is considered in the above equation, but maximization of fidelity may also be considered. Also, if

$${ρ}_{X} = {\sum }_{k} ( {μ}^{k} / k ! ) exp ( - μ ) \vert k ; X > < k ; X \vert$$

(k is a natural number), the above parameters can be selected as in the following formula (50):

ρ_{X}⁽⁰⁾=σ_{X}′=σ_{X}=|1;X><1;X|

p_{X}⁽⁰⁾=μexp(−μ)

μ_{XY}(|k;X><k;X|)=|k;Y><k;Y|

|φ_{KX}>=|φ> (50)

Let a portion of the subset K where ρᵢⱼ⁽⁰⁾ is output be L and a portion where ρᵢⱼ⁽¹⁾ is output be M. An upper limit n_{M+} of the length of the portion M and (a lower limit of) the amount of information R^{m}_{[M]} held by the portion M are estimated to calculate (an upper limit of) a probability ε_{E} that these estimations fail. This calculation can be carried out, for example, as shown below.

First, let δⁱ_{M} (i=0, 1) be an appropriate positive number. The upper limit nⁱ_{M+} (i=0, 1) of the length of the portion M is estimated according to the following formula (51):

pᵢ⁽¹⁾=(pᵢ₀pᵢ₀⁽¹⁾+pᵢ₁pᵢ₁⁽¹⁾)/(pᵢ₀+pᵢ₁)

pⁱ_{M}=((nⁱ_{M}/nⁱ_{A})−δⁱ_{M})/(pᵢ⁽¹⁾nⁱ_{K}/nⁱ_{D})

nⁱ_{M+}=max_{M}{nⁱ_{M}} (51)

where nⁱ_{K} (i=0, 1) represents the number of i (=0 or 1) in a[K]. Also, nⁱ_{A}, nⁱ_{D}, and nⁱ_{M} have similar meanings. Meanwhile, max_{M} indicates that maximization of M is to be performed under the condition pⁱ_{M}≦1. Also assuming that the receiver is surrounded by attackers, a still higher level of security can be ensured by replacing nⁱ_{D} in the formula (51) by nⁱ_{c}.

The upper limit of a probability that the estimation fails is calculated by the following formula (52). It is sufficient for the following upper limit εⁱ_{E} to be only an upper limit of a probability that the estimation fails and its form is not limited to the following form.

ε_{E}=ε⁰_{M}+ε¹_{M}

εⁱ_{M}=nⁱ_{A}exp(−nⁱ_{A}D(B(nⁱ_{M}/nⁱ_{A})|(B(nⁱ_{A}−δⁱ_{M}))) (52)

where exp is a power function of 2, D is a relative entropy, and B is a Bernoulli distribution.

Tᵢⱼ (i and j are either 0 or 1) is an operator in the Hilbert space H and is assumed to satisfy the following equation (53), where I is the identity operator in the Hilbert space H:

0≦Tᵢⱼ,Tᵢ₀+Tᵢ₁≦I (53)

Accordingly, if the basis in the portion M is i (=0 or 1), Tᵢⱼ can be considered to be a measurement operator to identify whether the source state is ρᵢ₀⁽¹⁾ or ρᵢ₁⁽¹⁾. A maximum value sⁱ_{M} of a probability that this identification is successful is calculated by the following formula (54):

$$\begin{matrix}{p}_{ij}^{( M )} = {p}_{ij} {p}_{ij}^{( 1 )} / ( {p}_{i 0} {p}_{i 0}^{( 1 )} + {p}_{i 1} {p}_{i 1}^{( 1 )} ) \\ {s}_{M ,}^{i} = {sup}_{T} \{ ( {\sum }_{j} {Trp}_{ij}^{( M )} {ρ}_{ij}^{( 1 )} {T}_{ij} ) / ( {\sum }_{k , 1} {Trp}_{ik}^{( M )} {ρ}_{ik}^{( 1 )} {T}_{il} ) \}\end{matrix} \qquad ( 54 )$$

where sup_{T} indicates that maximization of T is to be performed under the condition that the following equation (55) is satisfied:

$$( {\sum }_{jl} {Trp}_{ij}^{( M )} {ρ}_{ij}^{( 1 )} {T}_{il} ) ≧ {p}_{M}^{i} \qquad ( 55 )$$

A lower limit R_{X[M]} of the amount of information held by the portion M is calculated by the following formula (56):

R^{m}_{X[M]}=−n⁰_{M} log s⁰_{M}−n¹_{M} log s¹_{M} (56)

Next, the amount of information (Renyi entropy) held by the portion L is estimated. For this purpose, the error probability of the portion L is first estimated. Let δₚ be a security parameter. The following formula (57) is used for the estimated value P⁺.

P⁺=(n_{K}P_{R}+n_{c}δₚ−n⁰_{M}(1−s⁰_{M})−n¹_{M}(1−s¹_{M}))/n_{L} (57)

At this point, an upper limit εₚ of the probability Pr[P_{L}>P⁺] that the estimated value P⁺ of error probability is estimated to be smaller than the true value P_{L} is given by the following formula (58). It is sufficient for the following upper limit εₚ to be only an upper limit of a probability that the estimated value P⁺ is estimated to be smaller than the true value P_{L} and its form is not limited to the following formula:

εₚ=n_{R}exp(−n_{R}D(B(P_{R})|(B(P_{R}+δ_{dp})))≧Pr[P_{L}>P^{+]} (58)

An approximation protocol using the quantum state σ_{X} instead of the quantum state σ_{X}′ is considered. In this approximation protocol, the amount of information held by the portion L is estimated. For this purpose, a probability that the estimated value P⁺ is estimated to be smaller than the true value P_{K} when an inverted basis a^{˜}[L] is used instead of the basis a[L] in the portion L. Now, assume that σ₀′ and σ₁′ are average quantum states regarding the basis given by the following equation (59):

σ₀′=(σ₀₀′+σ₀₁′)/2

σ₁′=(σ₁₀′+σ₁₁′)/2 (59)

Further, let the upper limit of a trace distance between an average quantum state σ_{a[L]}′ corresponding to the basis a[L] and an average quantum state σ_{a˜[L]}′ corresponding to the inverted basis a^{˜}[L] be v. That is, v is assumed to satisfy the following equation (60):

d(σ_{a[L]}′,σ_{a˜[L]}′)≦υ (60)

Using the above equation, the upper limit of a probability that the estimated value P⁺ is estimated to be smaller than the true value P_{K} can be calculated as in the following formula (61):

Pr[P_{L}>P⁺]≦εₚ+ε_{E}+υ (61)

A variation distance between a probability distribution followed by transmission, reception, and intercepted information in a normal protocol and that followed by transmission, reception, and intercepted information in an approximation protocol is estimated. For this purpose, an upper limit τ satisfying the following equation (62) is calculated:

$${\sum }_{X [ L ]} ( 1 / {2}^{nL} ) d ( {σ}_{a} {{∼}_{[ L ] , x [ L ]}}^{′} , {σ}_{a} {∼}_{[ L ] , x [ L ]} ) ≦ τ \qquad ( 62 )$$

If, for example, f is fidelity between quantum states, the upper limit τ can be calculated by the following formula (63):

f_{X}=f(σ_{X}′,σ_{X})

f₀=min{f₀₀,f₀₁}

f₁=min{f₁₀,f₁₁}

τ=√(1−(f₀)²ⁿ⁰(f₁)²ⁿ¹) (63)

where n₀ and n₁ represent the number of 0 and that of 1 in the bit string a^{˜}[L] respectively.

The upper limit of a probability that the estimated value P⁺ is estimated to be smaller than the true value P_{K} when the inverted basis a^{˜}[L] is used can be calculated as in the following formula (64):

Pr[P⁺≦P_{K}]≦εₚ+ε_{E}+υ+τ (64)

Next, projection operators P₀₀, P₀₁, P₁₀, and P₁₁ in the Hilbert space H₂ are calculated according to the following formula (65):

P₀₀={σ₀₀−σ₀₁>0}

P₀₁={σ₀₁−σ₀₀>0}

P₁₀={σ₁₀−σ₁₁>0} (65)

Further, a maximum value s₀ of a probability that identification of the quantum states σ₀₀ and σ₀₁ is successful and a maximum value s₁ of a probability that identification of the quantum states σ₁₀ and σ₁₁ is successful are calculated according to the following formula (66):

s₀=½+d(σ₀₀,σ₀₁)

s₁₌½+d(σ₁₀,σ₁₁) (66)

Now, consider to estimate x[L] using the above projection operators when the quantum state σ_{a˜[L],x[L]} is given. Let the upper limit of an estimated error probability when k bits of errors are allowed for the estimated value (bit string corresponding to x[L]) be ε_{K}. ε_{K} can be calculated, for example, by the following formula (67):

$$\begin{matrix}{ɛ}_{k} = ( {2}^{nL} - {2}^{nLh ( k / nL )} / 2 / \sqrt{ } {n}_{L} ) {( {s}_{0} )}^{n 0} {( {s}_{1} )}^{n 1} {( ( 1 - {s}_{m} ) / {s}_{m} )}^{k} \\ {s}_{m} = min \{ {s}_{0} , {s}_{1} \}\end{matrix} \qquad ( 67 )$$

Using these values, a parameter ω_{L} is calculated by the following formula (68).

ω_{L}=εₚ+υ+τ+ε_{K}2^{nLh(P+)} (68)

If sₘ is 0, the following calculation is performed using the value of the following formula (69):

ω_{L}=εₚ+ε_{E}+υ+τ

k=0 (69)

Parameters q₀ and q₁ are calculated by the following formula (70):

q₀=max{Trσ₀₀P₁₀,Trσ₀₀P₁₁,Trσ₀₁P₁₀,Trσ₀₁P₁₁}

q₁=max{Trσ₁₀P₀₀,Trσ₁₀P₀₁,Trσ₁₁P₀₀,Trσ₁₁P₀₁}

Using these parameters, a parameter π_{L} is calculated by the following formula (71).

Π_{L}=2^{nLh(P*)+n0log(q0)+n1log(q1))}

P*=P⁺+(k/n_{L}) (71)

If c is a positive number, the following equation (72) holds from the Markov inequality for a conditional probability p_{x|yz} of transmission data when received data and intercepted information when an opposite basis is used are set as a condition.

Pr[p_{x|yx}>Π_{L}]≦(1/c)

Π_{L}=Π_{L}/(1−√(cω_{L}))² (72)

Here, the positive number c is determined so that the amount of information (Renyi entropy) R_{X} held by a key can be estimated to be as large as possible or the final amount of information (mutual information) held by a key (after compression) can be estimated to be as small as possible.

Using the formula (62) and formula (72) and selecting R^{m}_{X[L]} and ε_{L} appropriately, a conditional expression in the form of the equation (73) regarding the amount of information R_{X[L]} held by the portion L is derived.

Pr[R_{X[L]}>R^{m}_{X[L]}]≦ε_{L} (73)

If, for example, τ=0, R^{m}_{X[L]} and ε_{L} can be taken as shown in the following expression (74):

R^{m}_{X[L]}=−log Π_{L}

ε_{L}=1/c (74)

Further, the lower limit of the amount of information held by the portion K is calculated by the following formula (75):

R_{X}=R_{X[K]}=min_{M}(R^{m}_{X[L]}+R^{m}_{X[M]}) (75)

where min_{M} denotes minimization regarding M under the condition nⁱ_{M}≦nⁱ_{M+} (i=0, 1).

Next, a procedure for calculating an amount of information R_{X} held by a key using characteristics of a device on the detector side will be shown (corresponding to step S8, step S19). Quantum states (source states including source errors) of photons actually output from a source and polarized in the 0°, 90°, 45°, and 135° directions are denoted by ρ₀₀, ρ₀₁, ρ₁₀, and ρ₁₁ respectively. Also, each quantum state is assumed to be output with a probability of p₀₀, p₀₁, p₁₀, and P₁₁ respectively. Further, operators corresponding to measurement (measurement including detector errors) in the 0°, 90°, 45°, and 135° directions actually made by a detector are denoted by E₀₀, E₀₁, E₁₀, and E₁₁. Here, each operator is assumed to be a density operator in the Hilbert space H. These operators E₀₀, E₀₁, E₁₀, and E₁₁ are made public to the communication device on the sending side in advance. Also, the quantum states ρ₀₀, ρ₀₁, ρ₁₀, and ρ₁₁ are made public to the communication device on the receiving side in advance. However, if R_{X} is calculated by the communication device on the sending side and then a result thereof is made public to the receiving side, there is no need to make these values (quantum states) public.

In the communication device on the sending side, a quantum state ρᵢⱼ (i and j are either 0 or 1) is decomposed as shown in the following equation (76):

ρᵢⱼ=pᵢⱼ⁽⁰⁾ρᵢⱼ⁽⁰⁾+pᵢⱼ⁽¹⁾ρᵢⱼ⁽¹⁾ (76)

where ρᵢⱼ⁽⁰⁾ and ρᵢⱼ⁽¹⁾ are density operators in the Hilbert space H and are assumed to satisfy the following equation (77), and S(H) denotes for the Hilbert space H a set of quantum states in H.

0<p⁽⁰⁾≦min{pᵢⱼ}

pᵢⱼ⁽⁰⁾=p⁽⁰⁾/pᵢⱼ

pᵢⱼ⁽⁰⁾+pᵢⱼ⁽¹⁾=1

dimHᵢⱼ⁽⁰⁾=2 (77)

This decomposition is determined so that the amount of information R_{X} held by a key can be estimated to be as large as possible or the final amount of information held by a key (after compression) can be estimated to be as small as possible. In the following, the source is assumed to output ρᵢⱼ⁽⁰⁾ with a probability of pᵢⱼ⁽⁰⁾ and ρᵢⱼ⁽¹⁾ with a probability of pᵢⱼ⁽¹⁾.

X is assumed to take four values of 00, 01, 10, and 11 as above. P_{X}⁽⁰⁾ is a projection operator onto H_{X}⁽⁰⁾. Using the operator, an operator F_{X}′ on H_{X}⁽⁰⁾ is defined by the following equation (78):

F_{X}′=P_{X}⁽⁰⁾E_{X}P_{X}⁽⁰⁾ (78)

Further, let a two-dimensional Hilbert space of the Hilbert space be H₂. F_{X} (X=00, 01, 10, or 11) is assumed to be a quantum state in the Hilbert space H₂ satisfying the following equation (79), where I is the identity operator in the Hilbert space H₂.

F₀₀+F₀₁=I

F₁₀+F₁₁=I (79)

The Hilbert space H₂ and the operator F_{X} are selected so that Δ_{X} (X=00, 01, 10, or 11) defined by the following equation (80) or its upper limit is minimized.

Δ_{X}=d(F_{X}′,F_{X}) (80)

Now, assume that ρ₀⁽⁰⁾ and ρ₁⁽¹⁾ are average quantum states regarding the basis given by the following equation (81):

ρ₀⁽⁰⁾=(ρ₀₀⁽⁰⁾+ρ₀₁⁽⁰⁾)/2

ρ₁⁽⁰⁾=(ρ₁₀⁽⁰⁾+ρ₁₁⁽⁰⁾)/2 (81)

Further, let the upper limit of a trace distance between an average quantum state σ_{a[L]}⁽⁰⁾ corresponding to the basis a[L] and an average quantum state σ_{a˜[L]}⁽⁰⁾ corresponding to the inverted basis a^{˜}[L] be v. That is, v is assumed to satisfy the following equation (82):

d(ρ_{a[L]}⁽⁰⁾,ρ_{a∫[L]}⁽⁰⁾)≦υ (82)

In the following, calculations from the above formula (63) to the formula (75) are performed by replacing ρ with E and σ with F to determine the lower limit R_{X} of the amount of information held by the portion K.

Next, a quantum key distribution method (B92 protocol) using two non-orthogonal states is discussed. In this protocol, the steps S2, S3, S12, and S13 are replaced by the following steps. First, on the source side, a random bit string x[A] of length n_{A} is provided, and light polarized in the 0° direction is associated with bit 0 and light polarized in the 45° direction is associated with bit 1 (step S2). Based on this correspondence, the source side transmits photons to the receiving side (step S3). Also on the detector side, a random bit string a[A] of length n_{A} is provided, and a measuring apparatus that can identify light polarized in the horizontal/vertical directions (0°, 90°) is associated with bit 0 and a measuring apparatus that can identify light polarized in the slanting directions (45°, 135°) is associated with bit 1 (step S12). Based on this correspondence, the detector side measures photons transmitted from the receiving side (step S13). Although light polarized in the 45° direction is used in the present embodiment to make key generation efficient, it is sufficient for the polarized light not to intersect the horizontal direction at right angles.

Let a portion that could be received by the receiving side be D. If any result is obtained in the 90° or 135° direction, received data is denoted by 1 and 0 respectively. Otherwise, data is discarded. Let a portion of D retained without being discarded be C. Data obtained by the receiving side is denoted by y[C] (step S13). Transmission data corresponding to positions of the portion C is denoted by x[C] (step S3).

Steps S4 to S7 and steps S14 to S18 are performed as described above.

In the communication device on the sending side and communication device on the receiving side, (the lower limit of) the amount of information R_{X} held by a key (transmission data x[K]) in consideration of information leaked to an adversary through a quantum communication path is estimated (corresponding to step S8 and step S19). Here, the amount of information R held by a key may be calculated by both the communication device on the sending side and communication device on the receiving side, or may be calculated by the communication device on the sending side before a result thereof is made public to the receiving side. Particularly, a case in which R_{X} is calculated by both sides will be described below.

Quantum states (source states including source errors) of photons actually output from a source and polarized in the 0° and 45° directions are denoted by ρ₀ and ρ₁ respectively. Here, each quantum state is assumed to be a density operator in the Hilbert space H. Also, each quantum state is assumed to be output with a probability of p₀, and p₁ respectively. The quantum states ρ₀ and ρ₁ are made public to the communication device on the receiving side in advance. However, if R_{X} is calculated by the communication device on the sending side and then a result thereof is made public to the communication device on the receiving side, there is no need to make these values public.

In the communication device on the sending side, the quantum state ρᵢ (i is 0 or 1) is decomposed as shown in the following equation (83):

ρᵢ=pᵢ⁽⁰⁾ρᵢ⁽⁰⁾+pᵢ⁽¹⁾ρᵢ⁽¹⁾

0<p⁽⁰⁾≦min{pᵢ}

pᵢ⁽⁰⁾=p⁽⁰⁾/pᵢ

pᵢ⁽⁰⁾+pᵢ⁽¹⁾=1 (83)

This decomposition is determined so that the amount of information R_{X} held by a key can be estimated to be as large as possible. If, for example, d (p₀⁽¹⁾ρ₀⁽¹⁾, p₁⁽¹⁾ρ₁⁽¹⁾) is selected to be as small as possible and p₀⁽¹⁾+p₁⁽¹⁾ to be as large as possible, R_{X} can generally be estimated to be large. The source is assumed below to output ρᵢ⁽⁰⁾ with a probability of pᵢ⁽⁰⁾ and ρᵢ⁽¹⁾ with a probability of pᵢ⁽¹⁾.

X and Y are assumed to take two values of 0 and 1. Also, spectral decomposition of the above quantum state ρ_{X}⁽⁰⁾ is assumed to be

$${ρ}_{x}^{( 0 )} = {\sum }_{kX} {λ}_{X} ( {k}_{X} ) \vert {k}_{X} > < {k}_{X} \vert \qquad ( 84 )$$

and μ_{XY} to be a map from a set {k_{X}} to a set {k_{Y}}. Further, |φ_{KX}> is assumed to be an element of an appropriate Hilbert space. Here, a 2×2 Gram matrix G is calculated by the following formula (85):

$${G}_{XY} = {\sum }_{kX} < {k}_{X} \vert {k}_{XY} > < {ϕ}_{kX} \vert {ϕ}_{kXY} > \sqrt{ } ( {λ}_{X} ( {k}_{X} ) {λ}_{Y} ( {k}_{XY} ) ) \qquad ( 85 )$$

where k_{XY}=μ_{XY} (k_{X}). μ_{XY} and |φ_{KX}> are selected so that the amount of information R_{X} held by a key can be estimated to be as large as possible.

Since the Gram matrix G is positive semidefinite, a square matrix C of second order exists and the following equation (86) holds:

G=C*C (86)

Further, since the diagonal element of G is 1, a column vector of the matrix C can be considered to be an element of length 1 in the two-dimensional Hilbert space H₂. Thus, quantum states σ₀₀, σ₀₁, σ₁₀, and σ₁₁ in H₂ are defined by the following equation (87), where I is the identity operator in the Hilbert space H₂.

σ₀₀=|C₀><C₀|

σ₀₁=I−σ₀₀

σ₁₁=|C_{1><C}₁|

σ₁₀=I−σ₁₁ (87)

Here, C_{X} represents the X-th column of the matrix C. With this construction method of σ_{XY}, the existence of a completely-positive map from σ_{XY} to ρ_{X}⁽⁰⁾ is guaranteed. Thus in the following, σ_{XY} is considered to be output, instead of ρ_{X}⁽⁰⁾.

Let a portion of the subset K where ρᵢ⁽⁰⁾ is output be L and a portion where ρᵢ⁽¹⁾ is output be M. An upper limit n_{M+} of the length of the portion M and (a lower limit of) the amount of information R_{X[M]} held by the portion M are estimated to calculate (an upper limit of) a probability ε_{E} that these estimations fail. This calculation can be carried out, for example, as shown below. First, let δ_{L} be an appropriate positive number and estimate the upper limit n_{M+} of the length of the portion M according to the following formula (88):

p⁽¹⁾=p₀p₀⁽¹⁾+p₁p₁⁽¹⁾

p_{M}=((n_{M}/n_{A})−δ_{M})/(p⁽¹⁾n_{K}/n_{c})

n_{M+}=max_{M}{n_{M}} (88)

Meanwhile, max_{M} indicates that maximization of M is to be performed under the condition p_{M}≦1.

The upper limit of a probability that these estimations fail is calculated by the following formula (89).

ε_{E}=n_{A}exp(−n_{A}D(B(n_{M}/n_{A})|(B(n_{M}/n_{A}−δ_{M}))) (89)

Tᵢ (i is either 0 or 1) is an operator in the Hilbert space H and is assumed to satisfy the following equation (90), where I is the identity operator in the Hilbert space H:

0≦Tᵢ,T₀+T₁≦I (90)

Accordingly, Tᵢ can be considered to be a measurement operator to identify whether the source state is ρ₀⁽¹⁾ or ρ₁⁽¹⁾ in the portion M. The maximum value of a probability that this identification is successful is calculated by the following formula (91):

$$\begin{matrix}{p}_{i}^{( M )} = {p}_{i} {p}_{i}^{( 1 )} / ( {p}_{0} {p}_{0}^{( 1 )} + {p}_{1} {p}_{1}^{( 1 )} ) \\ {s}_{M} = {max}_{T} \{ ( {\sum }_{i} {Trp}_{i}^{( M )} {ρ}_{i}^{( 1 )} {T}_{i} ) / ( {\sum }_{i , j} {Trp}_{i}^{( M )} {ρ}_{i}^{( 1 )} {T}_{j} ) \}\end{matrix} \qquad ( 91 )$$

where max_{T} indicates that maximization of T is to be performed under the condition that the following equation (92) is satisfied:

$$( {\sum }_{ij} {Trp}_{i}^{( M )} {ρ}_{i}^{( 1 )} {T}_{j} ) ≧ {p}_{M} \qquad ( 92 )$$

Using the above values, a lower limit R_{X[M]} of the amount of information held by the portion M is calculated by the following formula (93):

R_{X[M]}=−n_{M} log s_{M} (93)

Calculations from the above formula (57) to the formula (75) are performed to determine the lower limit R_{X} of the amount of information held by the portion K, where parameters in the equation (94) are to take values in the equation.

σ₀₀′=σ₀₀,σ₀₁′=σ₀₁,σ₁₀′=σ₁₀,σ₁₁′=σ₁₁

Δ_{X}=0,υ=0,τ=0,εₖ=0,k=0 (94)

Next, in the quantum key distribution method (B92 protocol) using two non-orthogonal states, a procedure for calculating the amount of information R_{X} held by a key using characteristics of a device on the detector side will be shown (corresponding to step S8, step S19). Quantum states (source states including source errors) of photons actually output from a source and polarized in the 0° and 45° directions are denoted by ρ₀ and ρ₁ respectively. Also, each quantum state is assumed to be output with a probability of ρ₀ and ρ₁ respectively. Further, operators corresponding to measurement (measurement including detector errors) in the 0° and 45° directions actually made by a detector are denoted by E₀ and E₁. Here, each operator is assumed to be a density operator in the Hilbert space H. These operators E₀ and E₁ are made public to the communication device on the sending side in advance. Also, the quantum states ρ₀ and ρ₁ are made public to the communication device on the receiving side in advance. However, if R_{X} is calculated by the communication device on the sending side and then a result thereof is made public to the receiving side, there is no need to make these values (quantum states) public.

In the communication device on the sending side, a quantum state ρᵢⱼ (i is either 0 or 1) is decomposed as shown in the following equation (95):

ρᵢ=pᵢ⁽⁰⁾ρⱼ⁽⁰⁾+pᵢ⁽¹⁾ρᵢ⁽¹⁾ (95)

where ρᵢ⁽⁰⁾ and ρᵢ⁽¹⁾ are density operators in the Hilbert space H and are assumed to satisfy the following equation (96), and S(H) denotes for the Hilbert space H a set of quantum states in H.

0<p⁽⁰⁾≦min{pᵢⱼ}

pᵢⱼ⁽⁰⁾=p⁽⁰⁾/pᵢⱼ

pᵢⱼ⁽⁰⁾+pᵢⱼ⁽¹⁾=1

ρᵢ⁽⁰⁾εS(Hᵢ⁽⁰⁾) (96)

This decomposition is determined so that the amount of information R_{X} held by a key can be estimated to be as large as possible. The source is assumed below to output ρᵢ⁽⁰⁾ with a probability of pᵢ⁽⁰⁾ and ρᵢ⁽¹⁾ with a probability of pᵢ⁽¹⁾.

X is assumed to take two values of 0 and 1. P_{X}⁽⁰⁾ is a projection operator onto H_{X hu (0)}. Using the operator, an operator F_{X} on H_{X}⁽⁰⁾ is defined by the following equation (97):

F_{X}=P_{X}⁽⁰⁾E_{X}P_{X} (97)

Calculations from the above formula (57) to the formula (75) are performed below by replacing ρ with E and σ with F to determine the lower limit R_{X} of the amount of information held by the portion K, where parameters appearing in the above formula (88) to the formula (94) are to take values in each respective formula.

In the present embodiment, also in the communication device on the receiving side, the amount of information R_{X} held by a key is calculated by the same processing as that in step S8.

The key is compressed by the same procedure as that in steps S9 and S20 using the amount of information (n_{K}−R_{X}) instead of the amount of information I_{E}.

In the present embodiment, as described above, while correcting data errors of shared information using a deterministic parity check matrix for “Irregular-LDPC code” whose characteristics are stable, the above steps S4 and S14, the above steps S7 and S18, and the above steps S8 and S19 are performed, further data is compressed in accordance with the amount of information made public via the public communication path in a process of the above processing and estimated value of the amount of information leaked to an adversary through the quantum communication path, and the data after compression is made a cryptographic key shared by devices. Accordingly, a shared key whose security is ensured at a high level can efficiently be generated. That is, a quantum key distribution method whose success probability is 1-ε_{E}-εₚ-εₖ-ε_{c} or higher and the amount of information leaked to an adversary is (2⁻¹/ln 2)+n_{L}e_{L} or less can be realized. Meanwhile, ln denotes a logarithmic function using base e (natural logarithm).

### INDUSTRIAL APPLICABILITY

As has been described above, a quantum key distribution system and a communication device according to the present invention are useful as a technology for generating a shared key whose security is ensured at a high level and particularly suitable for communication on a transmission path where an adversary may be present.

1. A quantum key distribution method executed by a first communication device transmitting a quantum state specified by two random number sequences corresponding to a basis and data to a quantum communication path and a second communication device obtaining data by measuring the quantum state on the quantum communication path using the basis specified by the random number sequences with data obtained by measurement using the same basis as that of a sending side set as received data and a random number sequence corresponding to the received data set as transmission data; the method including:
an error probability estimation step of estimating an error probability of data used for key generation based on, after extracting data of predetermined numbers of pieces of the transmission data and the received data at the same positions, a degree of matching (error probability) of partial data after extraction, and
an information amount estimation step of estimating an amount of information leaked to an adversary through the quantum communication path based on an estimated value of the error probability and information about characteristics of a quantum state generator provided to the first communication device, wherein
each communication device makes the transmission data and the received data after compression based the estimated value of the amount of information leaked to the adversary a cryptographic key shared by each communication device.

2. The quantum key distribution method according to claim 1, wherein in the information amount estimation step, the amount of information leaked to the adversary through the quantum communication path is estimated based on the estimated value of error probability and information about characteristics of the quantum state generator provided to the first communication device and a quantum state measuring apparatus provided to the second communication device.

3. The quantum key distribution method according to claim 2, wherein in the information amount estimation step, the transmission data held by the first communication device and the received data held by the second communication device are each divided into a predetermined number of portions and an amount of information leaked to the adversary is estimated for each portion of the divided data.

4. The quantum key distribution method according to claim 1, further comprising:
a matching determination step of performing determination processing whether the transmission data held by the first communication device and the received data held by the second communication device match based predetermined determination information and, if a result of the determination is a mismatch, discarding data held by each of the communication devices, wherein
in the matching determination step,
the first communication device determines first determination information of a specific bit length by calculating “a predetermined random matrix×the transmission data held by the first communication device” as the predetermined determination information and transmits the first determination information to the second communication device via the public communication path,
the second communication device determines second determination information of the same bit length as that of the first determination information by calculating “the predetermined random matrix×the received data held by the second communication device” as the predetermined determination information and transmits the second determination information to the first communication device via the public communication path,
subsequently, the first communication device determines whether the first determination information and the second determination information obtained from the second communication device match as the determination processing, and
the second communication device, on the other hand, determines whether the second determination information and the first determination information obtained from the first communication device match as the determination processing.

5. The quantum key distribution method according to claim 1, wherein
if a two-level quantum system is assumed,
the information amount estimation step, includes:
a first process in which an upper limit of a variation distance between an approximation protocol (a protocol using a good-natured quantum state) that is relatively easy to analyze and an actual protocol (a protocol using a quantum state including transmission errors in an actual situation),
a second process in which the upper limit of a probability that the estimated value of error probability is estimated to be smaller than a true value when a basis that is opposite to an actual basis is used in the approximation protocol,
a third process in which the upper limit of a conditional probability of the received data and intercepted information when the transmission data is set as a condition is calculated,
a fourth process in which the amount of eavesdropping in the approximation protocol is calculated based on the upper limit of the probability that the estimated value of error probability is estimated to be smaller than the true value obtained in the second process and the upper limit of the conditional probability obtained in the third process, and
a fifth process in which the amount of eavesdropping in the actual protocol is calculated based on the amount of eavesdropping in the approximation protocol and the upper limit of the variation distance obtained in the first process and its result is set as the amount of information leaked to the adversary through the quantum communication path.

6. The quantum key distribution method according to claim 2, wherein
if a two-level quantum system is assumed,
the information amount estimation step, includes:
a first process in which an upper limit of a variation distance between an approximation protocol (a protocol using a good-natured operator) that is relatively easy to analyze and an actual protocol (a protocol using a measurement operator including reception errors in actual situations),
a second process in which the upper limit of a probability that the estimated value of error probability is estimated to be smaller than a true value when a basis that is opposite to the actual basis is used in the approximation protocol,
a third process in which the upper limit of a conditional probability of the received data and intercepted information when the transmission data is set as a condition is calculated,
a fourth process in which an amount of eavesdropping in the approximation protocol is calculated based on the upper limit of the probability that the estimated value of error probability is estimated to be smaller than the true value obtained in the second process and the upper limit of the conditional probability obtained in the third process, and
a fifth process in which the amount of eavesdropping in the actual protocol is calculated based on the amount of eavesdropping in the approximation protocol and the upper limit of the variation distance obtained in the first process and its result is set as the amount of information leaked to the adversary through the quantum communication path.

7. The quantum key distribution method according to claim 1, wherein
in the information amount estimation step, the amount of information held by the key is estimated based on characteristics of the quantum state generator provided to the first communication device or based on characteristics of the quantum state generator provided to the first communication device and a quantum state measuring apparatus provided to the second communication device and
each communication device compresses data held by each communication device based on the estimated value of the amount of information held by the key and makes the data after compression a cryptographic key shared by each communication device.

8. The quantum key distribution method according to claim 7, wherein
if a quantum system that is not necessarily two-level is assumed, a result of “non-detection” is assumed in addition to “0” and “1” as an observed value of the second communication device, further all transmission data is x[A], a portion of data of x[A] that can be detected by the second communication device is x[D], a portion of x[D] whose basis used on the sending side and that used on a receiving side is identical is x[C], partial data used in the error probability estimation step is x[R], and partial data for shared key generation (x[C]−x[R]) is x[K] (A, D, C, K, and R correspond to subsets showing bit positions), including:
a first process in which a quantum state is decomposed into a portion containing a first density operator (corresponding to a portion L of the subset K) in a Hilbert space and a portion containing a second density operator (corresponding to a portion M (=K−L) of the subset K) so that the amount of information held by the key can be estimated to be as large as possible,
a second process in which the amount of information held by the portion M is estimated,
a third process in which the amount of information held by the portion L is estimated, and
a fourth process in which the amount of information held by the portion K is calculated using the amount of information held by the portion M and that held by the portion L.

9. The quantum key distribution method according to claim 8, the method being applicable to a quantum key distribution method using two non-orthogonal states.

10. A communication system configured by a first communication device transmitting a quantum state specified by two random number sequences corresponding to a basis and data to a quantum communication path and a second communication device obtaining data by measuring the quantum state on the quantum communication path using the basis specified by the random number sequences to realize quantum key distribution in which the second communication device sets data obtained by measurement using the same basis as that of the first communication device as received data and the first communication device sets a random number sequence corresponding to the received data as transmission data, wherein
the first communication device, comprises:
a first shared key generation unit that extracts a predetermined number of pieces of first partial data from the transmission data, receives, on the other hand, second partial data (partial data extracted from the received data) at the same positions as those of the first partial data from the second communication device, estimates an error probability of data used for key generation based on a degree of matching (error probability) of both partial data, subsequently estimates an amount of information leaked to an adversary through a quantum communication path based on information of the estimated value of error probability and characteristics of a quantum state generator provided to the first communication device, and then makes the transmission data after compression based on the estimated value of the amount of information leaked to the adversary a cryptographic key shared by each communication device, and
the second communication device, comprises:
a second shared key generation unit that estimates the error probability of data used for key generation based on a degree of matching (error probability) of the second partial data and the first partial data received from the first communication device, subsequently estimates the amount of information leaked to the adversary through the quantum communication path based on the estimated value of error probability and information about characteristics of the quantum state generator provided to the first communication device, and then makes the received data after compression based on the estimated value of the amount of information leaked to the adversary a cryptographic key shared by each communication device.

11. The communication system according to claim 10, wherein the first and second shared key generation units estimate the amount of information leaked to the adversary through the quantum communication path based on the estimated value of error probability and information about characteristics of the quantum state generator provided to the first communication device and a quantum state measuring apparatus provided to the second communication device.

12. The communication system according to claim 10, wherein
the first and second shared key generation units
further perform determination processing based on predetermined determination information for determining whether the transmission data held by the first communication device and the received data held by the second communication device match and, if a result of the determination is a mismatch, performs processing to discard data held by each communication device, and
in the determination processing,
the first shared key generation unit determines first determination information of a specific bit length by calculating “a predetermined random matrix×the transmission data held by the first communication device” as the predetermined determination information and transmits the first determination information to the second communication device via a public communication path,
the second shared key generation unit determines second determination information of the same bit length as that of the first determination information by calculating “the predetermined random matrix×the received data held by the second communication device” as the predetermined determination information and transmits the second determination information to the first communication device via the public communication path,
subsequently, the first shared key generation unit determines whether the first determination information and the second determination information obtained from the second communication device match, and
the second shared key generation unit, on the other hand, determines whether the second determination information and the first determination information obtained from the first communication device match.

13. A communication device on a quantum state sending side that transmits a quantum state specified by two random number sequences corresponding to a basis and data to a quantum communication path and makes a random number sequence corresponding to data obtained by measurement using a same basis as that of the sending side by a communication device on a quantum state receiving side first transmission data, the device comprising:
an error probability estimation function that extracts data at a predetermined number of bit positions from the first transmission data, notifies the communication device on the receiving side of partial data after extraction via a public communication path, subsequently estimates an error probability of data used for key generation based on a degree of matching (error probability) with partial data at the same bit positions obtained from the communication device on the receiving side, and further makes remaining data excluding the partial data made public second transmission data,
an error correcting function that notifies the second communication device of predetermined error correcting information via the public communication path, compresses the second transmission data in accordance with an amount of the error correcting information made public, and makes the data after compression third transmission data,
a matching determination function that notifies the communication device on the receiving side of determination information used for determining whether the third transmission data and data obtained from the communication device on the receiving side match via the public communication path and, if a determination result based on the determination information is a mismatch, discards the third transmission data and, if, on the other hand, the determination result is a match, compresses the third transmission data in accordance with an amount of the determination information made public before making the data after compression fourth transmission data,
an estimation function that estimates the amount of information leaked to an adversary through the quantum communication path from the estimated error probability and information about characteristics of a source or a detector, and
a shared key generation function that compresses the fourth transmission data based on the estimated value of the amount of information leaked to the adversary and makes the data after compression a cryptographic key shared by devices.

14. A communication device on a quantum state receiving side that makes data obtained by measurement using a same basis as that on a quantum state sending side among data obtained by measurement using the basis specified by a random number sequence for a quantum state on a quantum communication path first received data, the device comprising:
an error probability estimation function that extracts data at a predetermined number of bit positions from the first received data, notifies the communication device on the photon sending side of partial data after extraction via a public communication path, subsequently estimates an error probability of data used for key generation based on a degree of matching (error probability) with partial data at the same bit positions obtained from the communication device on the sending side, and further makes remaining data excluding the partial data made public second received data,
an error correcting function that corrects errors of the second received data based on error correcting information obtained from the communication device on the sending side, compresses the second received data after error correction in accordance with an amount of the error correcting information made public by the communication device on the sending side, and makes the data after compression third received data,
a matching determination function that notifies the communication device on the sending side of determination information used for determining whether the third received data and data obtained from the communication device on the sending side match via the public communication path and, if a determination result based on the determination information is a mismatch, discards the third received data and, if, on the other hand, the determination result is a match, compresses the third received data in accordance with an amount of the determination information made public before making the data after compression fourth received data,
an estimation function that estimates the amount of information leaked to an adversary through the quantum communication path from the estimated error probability and information about characteristics of a source or a detector, and
a shared key generation function that compresses the fourth received data based on the estimated value of the amount of information leaked to the adversary and makes the data after compression a cryptographic key shared by devices.

15. A communication device on a sending side that transmits a quantum state specified by two random number sequences corresponding to a basis and data to a quantum communication path and makes a random number sequence corresponding to data obtained by measurement using a same basis as that of the sending side by a communication device on a quantum state receiving side first transmission data, the device comprising:
an error probability estimation function that extracts data at a predetermined number of bit positions from the first transmission data, notifies the communication device on the receiving side of partial data after extraction via a public communication path, subsequently estimates an error probability of data used for key generation based on a degree of matching (error probability) with partial data at the same bit positions obtained from the communication device on the receiving side, and further makes remaining data excluding the partial data made public second transmission data,
an error correcting function that notifies the second communication device of predetermined error correcting information via the public communication path, compresses the second transmission data in accordance with an amount of the error correcting information made public, and makes the data after compression third transmission data,
a matching determination function that notifies the communication device on the receiving side of determination information used for determining whether the third transmission data and data obtained from the communication device on the receiving side match via the public communication path and, if a determination result based on the determination information is a mismatch, discards the third transmission data and, if, on the other hand, the determination result is a match, compresses the third transmission data in accordance with an amount of the determination information made public before making the data after compression fourth transmission data,
an estimation function that estimates the amount of information held by a key based on characteristics of a quantum state generator or based on characteristics of the quantum state generator and a quantum state measuring apparatus provided to the communication device on the receiving side, and
a shared key generation function that compresses the fourth transmission data based on the estimated value of the amount of information held by the key and makes the data after compression a cryptographic key shared by devices.

16. A communication device on a quantum state receiving side that makes data obtained by measurement using a same basis as that on a quantum state sending side among data obtained by measurement using the basis specified by a random number sequence for a quantum state on a quantum communication path first received data, the device comprising:
an error probability estimation function that extracts data at a predetermined number of bit positions from the first received data, notifies the communication device on the photon sending side of partial data after extraction via a public communication path, subsequently estimates an error probability of data used for key generation based on a degree of matching (error probability) with partial data at the same bit positions obtained from the communication device on the sending side, and further makes remaining data excluding the partial data made public second received data,
an error correcting function that corrects errors of the second received data based on error correcting information obtained from the communication device on the sending side, compresses the second received data after error correction in accordance with an amount of the error correcting information made public by the communication device on the sending side, and makes the data after compression third received data,
a matching determination function that notifies the communication device on the sending side of determination information used for determining whether the third received data and data obtained from the communication device on the sending side match via the public communication path and, if a determination result based on the determination information is a mismatch, discards the third received data and, if, on the other hand, the determination result is a match, compresses the third received data in accordance with an amount of the determination information made public before making the data after compression fourth received data,
an estimation function that estimates the amount of information held by a key based on characteristics of a quantum state generator provided to the communication device on the sending side or based on characteristics of the quantum state generator and a quantum state measuring apparatus, and
a shared key generation function that compresses the fourth received data based on the estimated value of the amount of information held by the key and makes the data after compression a cryptographic key shared by devices.

17. A communication device on a sending side that transmits a quantum state specified by random number sequences corresponding to data to a quantum communication path and makes a random number sequence corresponding to a quantum state neither matching nor orthogonal to a measurement result in a communication device on a quantum state receiving side first transmission data, the device comprising:
an error probability estimation function that extracts data at a predetermined number of bit positions from the first transmission data, notifies the communication device on the receiving side of partial data after extraction via a public communication path, subsequently estimates an error probability of data used for key generation based on a degree of matching (error probability) with partial data at same bit positions obtained from the communication device on the receiving side, and further makes remaining data excluding the partial data made public second transmission data,
an error correcting function that notifies the second communication device of predetermined error correcting information via the public communication path, compresses the second transmission data in accordance with an amount of the error correcting information made public, and makes the data after compression third transmission data,
a matching determination function that notifies the communication device on the receiving side of determination information used for determining whether the third transmission data and data obtained from the communication device on the receiving side match via the public communication path and, if a determination result based on the determination information is a mismatch, discards the third transmission data and, if, on the other hand, the determination result is a match, compresses the third transmission data in accordance with an amount of the determination information made public before making the data after compression fourth transmission data,
an estimation function that estimates the amount of information held by a key based on characteristics of a quantum state generator or based on characteristics of the quantum state generator and a quantum state measuring apparatus provided to the communication device on the receiving side, and
a shared key generation function that compresses the fourth transmission data based on the estimated value of the amount of information held by the key and makes the data after compression a cryptographic key shared by devices.

18. A communication device on a quantum state receiving side that makes data corresponding to a measurement result neither matching nor orthogonal to a quantum state on the sending side among data obtained by measurement using a basis specified by a random number sequence for a quantum state on a quantum communication path first received data, the device comprising:
an error probability estimation function that extracts data at a predetermined number of bit positions from the first received data, notifies the communication device on the photon receiving side of partial data after extraction via a public communication path, subsequently estimates an error probability of data used for key generation based on a degree of matching (error probability) with partial data at same bit positions obtained from the communication device on the sending side, and further makes remaining data excluding the partial data made public second received data,
an error correcting function that corrects errors of the second received data based on error correcting information obtained from the communication device on the sending side, compresses the second received data after error correction in accordance with an amount of the error correcting information made public by the communication device on the sending side, and makes the data after compression third received data,
a matching determination function that notifies the communication device on the sending side of determination information used for determining whether the third received data and data obtained from the communication device on the sending side match via the public communication path and, if a determination result based on the determination information is a mismatch, discards the third received data and, if, on the other hand, the determination result is a match, compresses the third received data in accordance with an amount of the determination information made public before making the data after compression fourth received data,
an estimation function that estimates the amount of information held by a key based on characteristics of a quantum state generator provided to the communication device on the
sending side or based on characteristics of the quantum state generator and a quantum state measuring apparatus, and
a shared key generation function that compresses the fourth received data based on the estimated value of the amount of information held by the key and makes the data after compression a cryptographic key shared by devices.
